(19) United States
(12) Patent Application Publication
(10) Pub. No.: US 2018/0060131 A1
(43) Pub. Date: Mar. 1, 2018

(54) INFORMATION PROCESSING SYSTEM, INFORMATION PROCESSING APPARATUS, AND INFORMATION PROCESSING METHOD

(71) Applicants: Kohsuke NAMIHIRA, Ibaraki (JP); Yuuichiroh HAYASHI, Kanagawa (JP); Ryohsuke YOSHIHASHI, Kanagawa (JP)

(72) Inventors: Kohsuke NAMIHIRA, Ibaraki (JP); Yuuichiroh HAYASHI, Kanagawa (JP); Ryohsuke YOSHIHASHI, Kanagawa (JP)

(73) Assignee: Ricoh Company, Ltd., Tokyo (JP)

(21) Appl. No.: 15/671,318

(22) Filed: Aug. 8, 2017

(30) Foreign Application Priority Data
Aug. 29, 2016 (JP) 2016-167332

(51) Int. Cl. G06F 9/50; G06F 9/30; G06F 11/07

(52) U.S. Cl. CPC G06F 9/5033; H04L 47/2441; G06F 11/0724; G06F 9/30003

(57) ABSTRACT

An information processing system includes a memory and processors. The memory stores flow information and flow identification information for each sequence of processes performed by using electronic data. The flow information defines program identification information identifying programs for executing the sequence of processes, and an execution order of the programs. The processors execute computer-executable instructions stored in the memory to execute a process including receiving information relating to the electronic data and flow identification information, from a device coupled to the information processing system; acquiring the flow information stored in association with the received flow identification information; provisionally executing the sequence of processes based on the received information and the acquired flow information; and executing the sequence of processes based on the received information and the acquired flow information, upon determining that an error has not occurred in the provisional execution of the sequence of processes.

### CROSS-REFERENCE TO RELATED APPLICATION

The present application claims priority under 35 U.S.C. §119 of Japanese Patent Application No. 2016-167332, filed on Aug. 29, 2016, the contents of which are incorporated herein by reference in their entirety.

### BACKGROUND OF THE INVENTION

### 1. Field of the Invention

The present invention relates to an information processing system, an information processing apparatus, and an information processing method.

### 2. Description of the Related Art

In recent years, a service for providing a function formed by combining a plurality of functions (for example, scanning, printing, and uploading to an external service, etc.) has become known. For example, there is a known service of uploading electronic data, which has been generated by a scanning process, to an external service, etc. This type of service is implemented by executing a one or more processes implementing the functions, as a sequence of processes.

Furthermore, there is a known image forming apparatus that executes the sequence of processes based on an instruction including processing information, etc., expressing one or more processes as the sequence of processes (see, for example, Patent Document 1).

Patent Document 1: Japanese Patent No. 4039191

### SUMMARY OF THE INVENTION

An aspect of the present invention provides an information processing system, an information processing apparatus, and an information processing method in which one or more of the above-described disadvantages are reduced.

According to one aspect of the present invention, there is provided an information processing system including one or more information processing apparatuses configured to implement various functions of the information processing system, the information processing system including a memory to store flow information and flow identification information identifying the flow information, in association with each other, for each sequence of processes performed by using electronic data, the flow information defining program identification information identifying one or more programs for respectively executing the processes included in the sequence of processes, the flow information also defining an execution order of executing the one or more programs, and computer-executable instructions; and one or more processors configured to execute the computer-executable instructions such that the one or more processors execute a process including receiving, over a communication network, information relating to the electronic data and flow identification information, from one of one or more devices coupled to the information processing system, according to an operation input via a user interface of the one of one or more devices; acquiring the flow information stored in association with the received flow identification information, among the flow information stored in the memory; provisionally executing the sequence of processes using the electronic data based on the received information relating to the electronic data, by respectively provisionally executing the one or more programs identified by the program identification information defined in the acquired flow information, in the execution order defined in the acquired flow information; and executing the sequence of processes using the electronic data based on the received information relating to the electronic data, by respectively executing the one or more programs identified by the program identification information defined in the acquired flow information, in the execution order defined in the acquired flow information, upon determining that an error has not occurred in the provisional execution of the sequence of processes.

### BRIEF DESCRIPTION OF THE DRAWINGS

FIG. 1 is a diagram illustrating an exemplary system configuration of an information processing system according to an embodiment of the present invention;

FIG. 2 is a diagram illustrating a hardware configuration of an exemplary service providing system according to an embodiment of the present invention;

FIG. 3 is a diagram illustrating a hardware configuration of an exemplary device according to an embodiment of the present invention;

FIG. 4 illustrates a functional configuration of an example of the information processing system according to an embodiment of the present invention;

FIGS. 5A through 5D illustrate examples of a common interface (I/F) and a unique I/F according to an embodiment of the present invention;

FIG. 6 illustrates a functional configuration of an example of a logic processing unit according to an embodiment of the present invention;

FIG. 7 illustrates an example of a format conversion information table according to an embodiment of the present invention;

FIG. 8 illustrates an example of process flow information according to an embodiment of the present invention;

FIG. 9 is a sequence diagram of an example of the overall process of an “Optical Character Recognition (OCR) delivery A” service according to an embodiment of the present invention;

FIG. 10 illustrates an example of screen information according to an embodiment of the present invention;

FIG. 11 illustrates an example of an application screen according to an embodiment of the present invention;

FIG. 12 is a sequence diagram of an example of the process of executing the process flow according to an embodiment of the present invention;

FIG. 13 is a sequence diagram of an example of a process of provisionally executing an OCR component according to an embodiment of the present invention;

FIG. 14 is a sequence diagram of an example of a process of provisionally executing a delivery A component according to an embodiment of the present invention;

FIG. 15 a sequence diagram of an example of a process of formally executing the OCR component according to an embodiment of the present invention;

FIG. 16 is a sequence diagram of an example of a process of formally executing the delivery A component according to an embodiment of the present invention; and

FIG. 17 is a sequence diagram of another example of the process of executing the process flow according to an embodiment of the present invention.

### DETAILED DESCRIPTION OF THE PREFERRED EMBODIMENTS

In the technology of the related art, when an error, etc., occurs in the sequence of processes, there have been cases where it takes time until the occurrence of the error, etc., is reported to the user. That is, for example, when an error, etc., occurs in the last process executed among the processes of the sequence of processes, the user needs to wait for the last process to be executed and the error, etc., to be reported.

A problem to be solved by an embodiment of the present invention is to reduce the waiting time in a case where an error occurs in a sequence of processes.

Embodiments of the present invention will be described by referring to the accompanying drawings.

### <System Configuration>

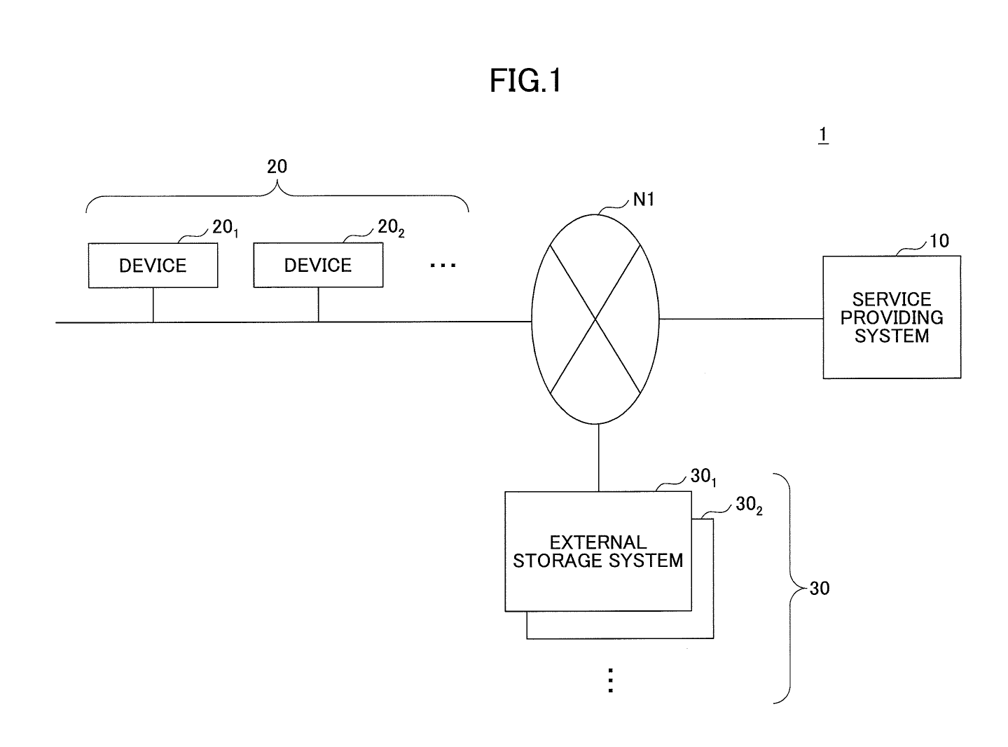

Referring to FIG. 1, an information processing system 1 according to the first embodiment is described. FIG. 1 is a diagram illustrating an exemplary system configuration of the information processing system 1 according to the first embodiment.

The information processing system 1 illustrated in FIG. 1 includes a service providing system 10, a device 20, and an external storage system 30, which are communicably coupled through a wide area network N1 such as the Internet.

The service providing system 10 is implemented by at least one information processing apparatus and provides various services implemented by a sequence of processes, which cooperate with an external service such as cloud service via the network N1.

The service provided by the service providing system 10 according to the first embodiment is specifically described below. Hereinafter, the sequence of processes is referred to as a “process flow”.

Although the external service to be described in the first embodiment is specifically the cloud service, the external service is not limited to this cloud service. For example, the first embodiment may be applied to various external services such as a service provided by an application service provider (ASP) and a web service, which are provided via the network.

The devices 20 are various electronic devices used by a user. That is, the device 20 is, for example, an image forming apparatus such as a multifunction peripheral (MFP), a personal computer (PC), a projector, an electronic whiteboard, a digital camera, or the like. The user uses the device 20 to use various services provided by the service providing system 10.

Hereinafter, when each of the plurality of devices 20 is distinguished, a suffix is added such as a “device 20₁” and a “device 20₂”.

The external storage system 30 is a computer system providing a cloud service called a storage service (or an online storage). The storage service is a service of lending a memory area of a storage of the external storage system 30.

Hereinafter, when each of the plurality of external storage systems 30 is distinguished, a suffix is added such as an “external storage system 30₁” and an “external storage system 30₂”. Further, the name of the storage service provided by the external storage system 30₁ is “storage A”, and the name of the storage service provided by the external storage system 30₂ is “storage B”.

The external storage system 30 may be a system implemented by a plurality of information processing apparatuses.

The configuration of the information processing system 1 illustrated in FIG. 1 is an example and may have other configurations. For example, the information processing system 1 according to the first embodiment includes various devices, each of which performs at least one of an input and an output of the electronic data. These devices may use various services provided by the service providing system 10.

### <Hardware Configuration>

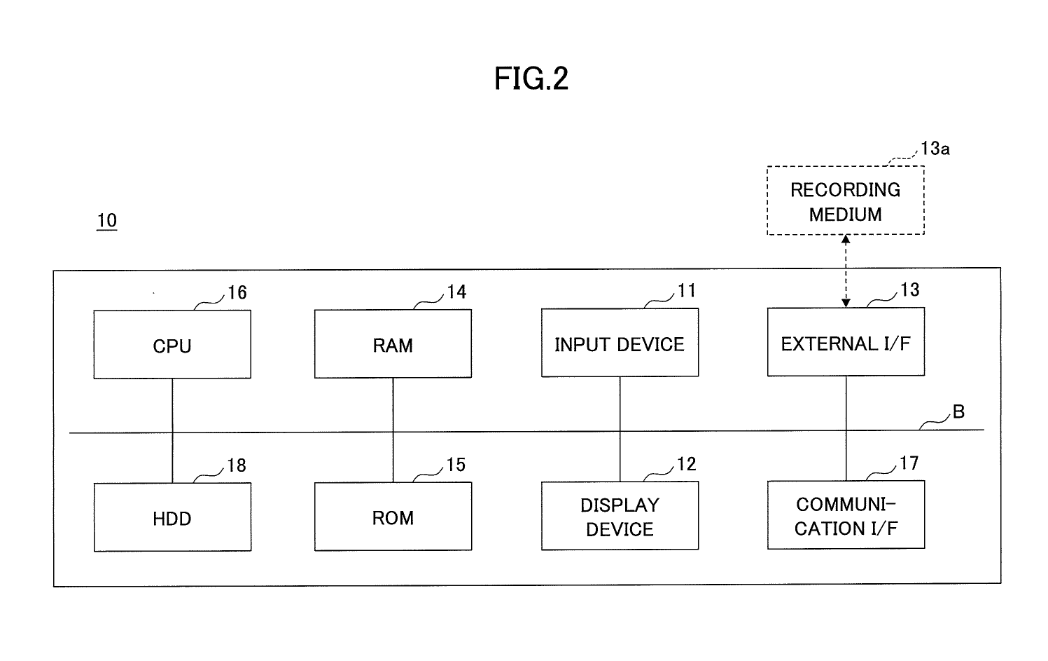

Referring to FIG. 2, described next is the hardware configuration of the service providing system 10 included in the information processing system 1 according to the first embodiment. FIG. 2 is a diagram illustrating the hardware configuration of an exemplary service providing system 10 according to the first embodiment.

The service providing system 10 illustrated in FIG. 2 includes an input device 11, a display device 12, an external interface (I/F) 13, and a random access memory (RAM) 14. Further, the service providing system 10 includes a read only memory (ROM) 15, a central processing unit (CPU) 16 (an example of one or more processors), a communication interface (I/F) 17, and a hard disk drive (HDD) 18. Each of the ROM 15, the CPU 16, a communication I/F 17, and the HDD 18 is connected by the bus B.

The input device 11 includes a keyboard, a mouse, a touch panel, and the like, by which the user inputs various operation signals. The display device 12 includes a display or the like to display a processing result acquired by the service providing system 10. At least one of the input device 11 and the display device 12 may be in a mode of being coupled to the service providing system 10 so as to be used.

The communication I/F 17 is an interface provided to couple the service providing system 10 with the network N1. Thus, the service providing system 10 can communicate with another device through the communication I/F 17.

The HDD 18 is a non-volatile memory device that stores programs and data. The program and data stored in the HDD 18 are an operating system (OS), which is basic software controlling the entire service providing system 10, application software providing various functions in the OS, and so on.

The service providing system 10 may use a drive device (e.g., a solid state drive (SSD)) using a flash memory as a memory medium in place of the HDD 18. Further, the HDD 18 administers the stored program and the stored data using at least one of a predetermined file system and a predetermined database (DB).

The external I/F 13 is an interface with an external device. The external device includes a recording medium 13a and so on. With this configuration, the service providing system 10 can read information from the recording medium 13a and write information to the recording medium 13a through the external I/F 13. The recording medium 13a is a flexible disk, a CD, a DVD, an SD memory card, a USB memory, or the like.

The ROM 15 is a non-volatile semiconductor memory that can store a program or data even when a power source is powered off. The ROM 15 stores a program and data such as a basic input/output system (BIOS), an operating system (OS) setup, a network setup, or the like, which are executed at a time of starting up the service providing system 10. The RAM 14 is a volatile semiconductor memory configured to temporarily store the program and the data.

The CPU 16 reads the program and/or data from the memory device such as the ROM 15 and the HDD 18. The read program or the read data undergo a process to thereby realize control or a function of the entire service providing system 10.

The service providing system 10 of this embodiment can realize various processes described below by having the above hardware configuration of the service providing system 10 illustrated in FIG. 2.

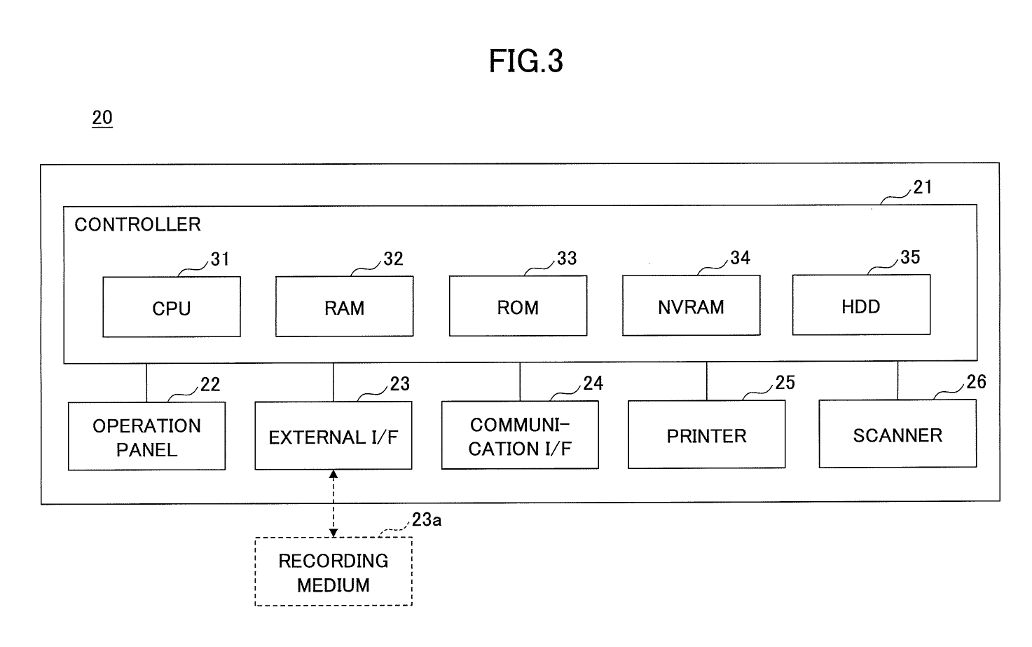

Referring to FIG. 3, described next is the hardware configuration of an image forming apparatus, which is the device 20 included in the information processing system 1 of the embodiment. FIG. 3 is a diagram illustrating a hardware configuration of an exemplary device 20 according to the first embodiment.

The device 20 illustrated in FIG. 3 includes a controller 21, an operation panel 22, an external interface (I/F) 23, a communication I/F 24, a printer 25, and a scanner 26. The controller 21 includes a central processing unit (CPU) 31 (an example of one or more processors), a random access memory (RAM) 32, a read only memory (ROM) 33, a non-volatile random access memory (NVRAM) 34, and a hard disk drive (HDD) 35.

The ROM 33 is a non-volatile semiconductor memory that stores various programs and data. The RAM 32 is a volatile semiconductor memory configured to temporarily store the program and the data. For example, setup information or the like is stored in the NVRAM 34. The HDD 35 is a non-volatile memory device that stores the various programs and data.

The CPU 31 reads the program, the data, setup information, or the like into the RAM 32 from the ROM 33, the NVRAM 34, the HDD 35, or the like, and executes the process. Thus, the CPU 31 is an arithmetic device implementing control and a function of the entire device 20.

The operation panel 22 includes an input unit configured to receive an input from the user and a display unit configured to display. The external I/F 23 is an interface with the external device. The external device includes a recording medium 23a and so on. With this, the device 20 can perform at least one of reading information from the recording medium 23a through the external I/F 23 and writing the information to the recording medium 23a through the external I/F 23. The recording medium 23a is, for example, an IC card, a flexible disk, a compact disc (CD), a digital versatile disc (DVD), a secure digital (SD) memory card, and a universal serial bus (USB) memory.

The communication I/F 24 is an interface coupling the device 20 with the network. Thus, the device 20 can perform data communications through the communication I/F 24. The printer 25 is provided to print data. The scanner 26 is a reading device that reads an original and generates an electronic file (an image file).

The device 20 according to the first embodiment includes a hardware configuration illustrated in FIG. 3 to realize various processes described below.

### <Service Provided by Service Providing System>

The service provided by the service providing system 10 according to the present embodiment is described. Hereinafter, a description is given of a case where the device 20 is an image forming apparatus.

For example, the service providing system 10 according to the present embodiment provides a service of performing an Optical Character Recognition (OCR) process on an electronic file that has been generated by scanning an original document at the device 20, and then storing the electronic file in the external storage system 30₁ (storage A).

The following description is given based on the assumption that the service providing system 10 according to the present embodiment provides the above-described service (hereinafter, also referred to as an “OCR delivery A” service).

However, the service provided by the service providing system 10 is not limited as such. For example, the service providing system 10 may provide a service of performing an OCR process on an electronic file that has been generated by scanning an original document at the device 20, and then sending the electronic file by mail to a predetermined mail address. Furthermore, for example, the service providing system 10 may provide a service of printing an electronic file, which is stored in the external storage system 30, by the device 20.

### <Functional Configuration>

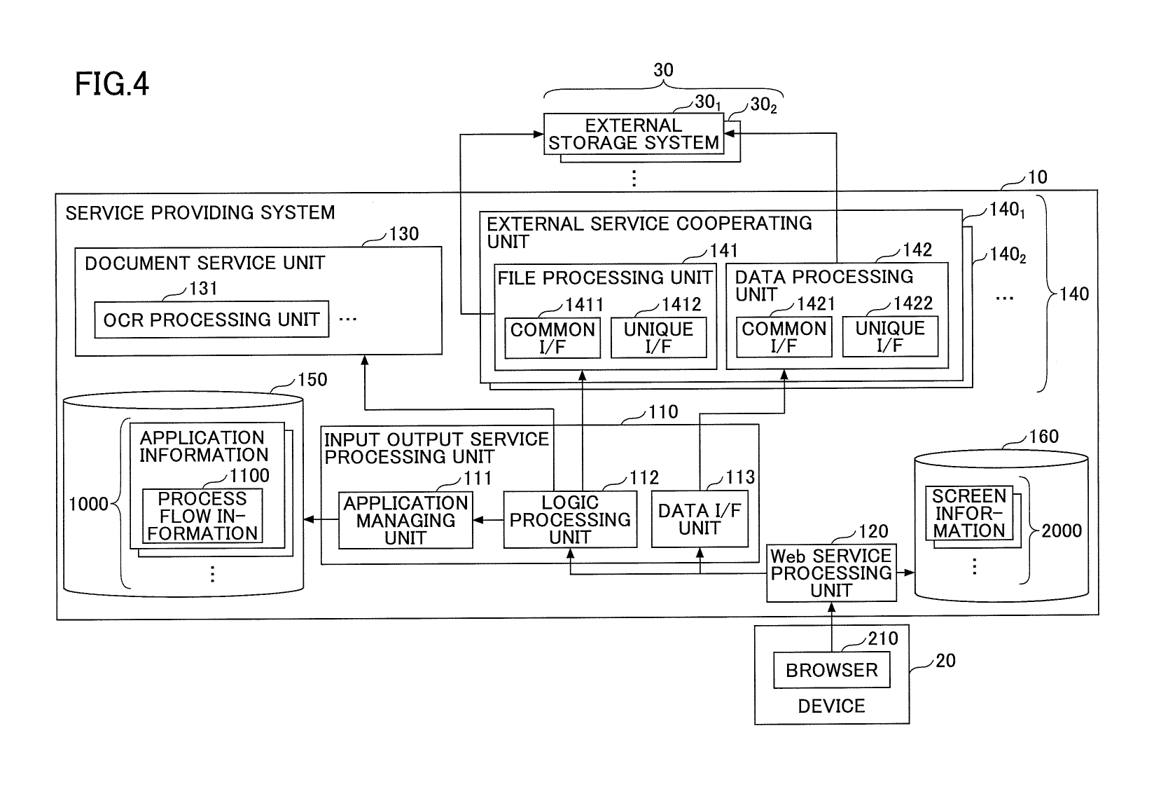

Next, a description is given of a functional configuration of the information processing system 1 according to the present embodiment, by referring to FIG. 4. FIG. 4 illustrates a functional configuration of an example of the information processing system 1 according to the present embodiment.

The device 20 illustrated in FIG. 4 includes a web browser 210 (hereinafter, simply referred to as a “browser 210”) executed by, for example, the CPU 31, etc. The user of the device 20 is able to use a service provided by the service providing system 10, by using the browser 210.

In this way, the device 20 according to the present embodiment can function by having the browser 210 installed. Therefore, in the device 20 according to the present embodiment, for example, there is no need to install an exclusive-use application program, etc., for using a service provided by the service providing system 10.

The service providing system 10 illustrated in FIG. 4 includes an input output service processing unit 110, a web service processing unit 120, a document service unit 130, and an external service cooperating unit 140. These units are implemented by processes that the CPU 16 is caused to execute by one or more programs installed in the service providing system 10.

Furthermore, the service providing system 10 includes an application information storage unit 150 and a screen information storage unit 160. These storage units can be implemented by the HDD 18. Note that at least one storage unit among the application information storage unit 150 and the screen information storage unit 160 may be implemented by a storage device, etc., that is coupled to the service providing system 10 via a network.

The input output service processing unit 110 performs a process relevant to a service provided by the service providing system 10. Here, the input output service processing unit 110 includes an application managing unit 111, a logic processing unit 112, and a data I/F unit 113.

The application managing unit 111 manages application information 1000 stored in the application information storage unit 150. Note that the application information 1000 is an application for providing a service implemented by a sequence of processes. That is, various services provided by the service providing system 10 are provided according to the application information 1000.

Furthermore, the application managing unit 111 returns process flow information 1100 included in the application information 1000, in response to a request from the logic processing unit 112. Note that the process flow information 1100 is information defining a sequence of processes for implementing a service provided according to the application information 1000.

The logic processing unit 112 acquires the process flow information 1100, which is included in the application information 1000, from the application managing unit 111, in response to a request from the web service processing unit 120. Then, the logic processing unit 112 executes a sequence of processes (a process flow) for implementing a service provided according to the application information 1000, based on the process flow information 1100 acquired from the application managing unit 111. Accordingly, the service providing system 10 according to the present embodiment is able to provide various services. Note that details of the logic processing unit 112 are described below.

The data I/F unit 113 makes various requests (for example, a request to acquire a folder list, etc.) to a data processing unit 142 of the external service cooperating unit 140, in response to a request from the web service processing unit 120.

The web service processing unit 120 returns screen information 2000 stored in the screen information storage unit 160, in response to a request from the browser 210. Note that the screen information 2000 is information defining a screen (application screen) for using a service provided according to the application information 1000. In the screen information 2000, an application screen is defined in a format interpretable by the browser 210, such as HyperText Markup Language (HTML), Extensible HyperText Markup Language (XHTML), Cascading Style Sheets (CSS), and JavaScript (registered trademark).

Accordingly, on the operation panel 22 of the device 20, an application screen for using a service provided by the service providing system 10, is displayed by the browser 210.

Furthermore, the web service processing unit 120 makes various requests to the input output service processing unit 110, in response to a request from the browser 210. For example, the web service processing unit 120 makes a request to execute a process flow for implementing the “OCR delivery A” service to the logic processing unit 112 of the input output service processing unit 110, in response to a request from the browser 210.

The document service unit 130 executes predetermined processes included in a sequence of processes (process flow) based on the process flow information 1100. The document service unit 130 includes an OCR processing unit 131. The OCR processing unit 131 performs an OCR process on an electronic file (image file).

Note that the document service unit 130 may also include, for example, a data converting unit for converting a data format of an electronic file into a predetermined data format, a compression/decompression processing unit for compressing or decompressing an electronic file, and a mail delivering unit for delivering a mail, to which an electronic file is attached, etc.

As described above, the document service unit 130 includes various functional units for executing predetermined processes included in a sequence of processes (process flow). Therefore, the document service unit 130 is implemented by a group of programs (modules) for providing the various functions.

The external service cooperating unit 140 makes various requests (for example, a request to acquire a folder list, etc.) to the external storage system 30, in response to a request from the logic processing unit 112 and the data I/F unit 113.

The service providing system 10 according to the present embodiment includes the external service cooperating unit 140 corresponding to each external storage system 30 that performs processes in cooperation with the service providing system 10. That is, the service providing system 10 according to the present embodiment includes the external service cooperating unit 140₁ for making various requests to the external storage system 30₁. Similarly, the service providing system 10 according to the present embodiment includes the external service cooperating unit 140₂ for making various requests to the external storage system 30₂, etc.

Note that in the following, when each of the plurality of external service cooperating units 140 is distinguished, a suffix is added such as the “external service cooperating unit 140₁” and the “external service cooperating unit 140₂”.

Here, the external service cooperating unit 140 includes a file processing unit 141 for receiving a request from the logic processing unit 112 and the data processing unit 142 for receiving a request from the data I/F unit 113.

The file processing unit 141 includes a common I/F 1411 and a unique I/F 1412, defining an application programming interface (API) for conducting a file operation (e.g., an acquisition operation, a storage operation, and an edit operation) to the electronic file stored in the external storage system 30.

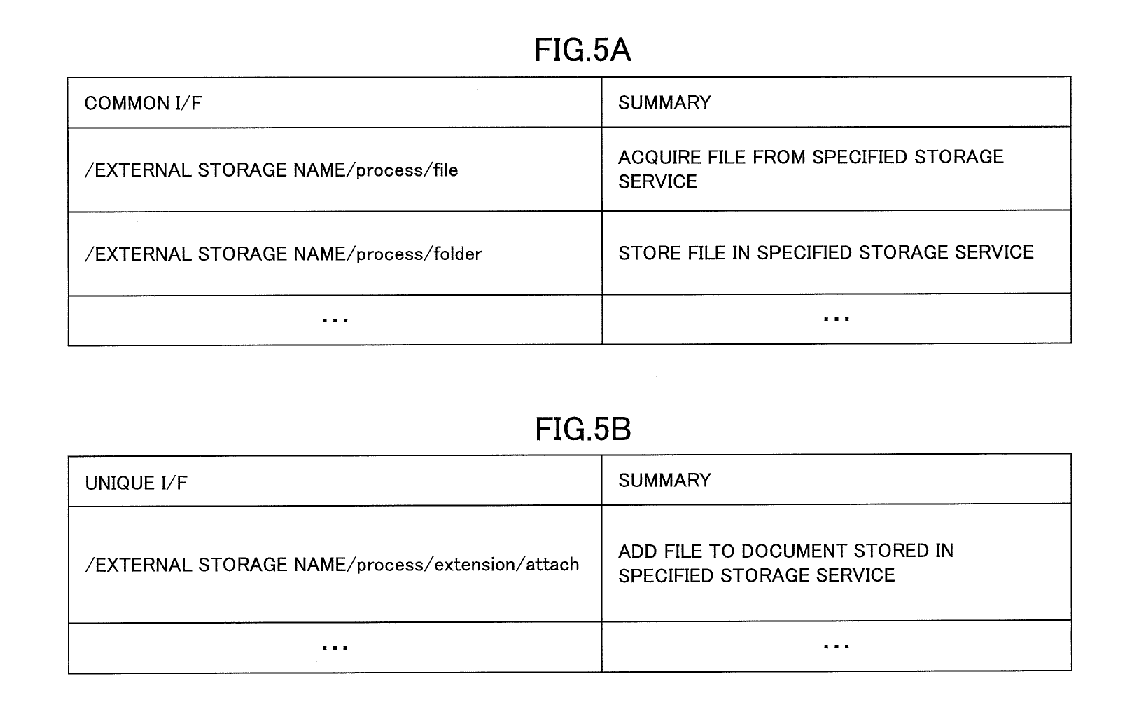

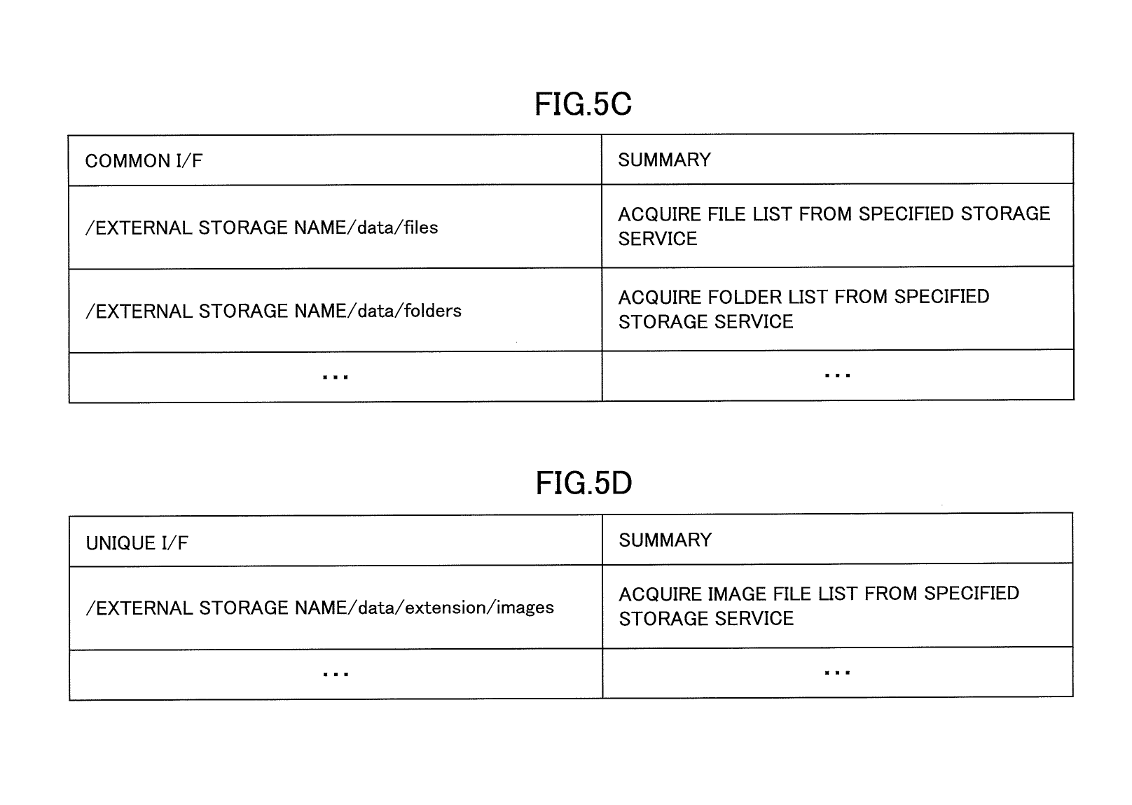

The common I/F 1411 is an API commonly used among the plurality of external storage systems 30 as, for example, the API illustrated in FIG. 5A. That is, the common I/F 1411 of the file processing unit 141 is a group of APIs for using a function (e.g., a file acquisition function, and a file storage function) related to the file operation which can be used by all of the external storage systems 30.

The unique I/F 1412 is an API used by a specific external storage system 30 as, for example, the API illustrated in FIG. 5B. That is, the unique I/F 1412 of the file processing unit 141 is an API group of APIs for using a function (e.g., adding a file to a document) related to the file operation that can be used in the specific external storage system 30.

Therefore, the common I/F 1411 is similarly defined for all the external service cooperating units 140. On the other hand, the unique I/F 1412 is defined for the external service cooperating unit 140 corresponding to the specific external storage system 30, in which the API defined by the unique I/F 1412 can be used.

The data processing unit 142 includes a common I/F 1421 and a unique I/F 1422, in which an API for acquiring meta data (e.g., a file list and a folder list) of bibliographic information of the electronic file stored in the external storage system 30 is defined.

The common I/F 1421 is an API commonly used among the plurality of external storage systems 30 as, for example, the API illustrated in FIG. 50. That is, the common I/F 1421 of the data processing unit 142 is an API group of APIs for using a function (e.g., a function of acquiring a list of files and a function of acquiring a list of folders) related to meta data acquisition that can be used by all the external storage systems 30.

The unique I/F 1422 is an API, which can be used by the specific external storage system 30, such as the API illustrated in FIG. 5D. That is, the unique I/F 1422 of the data processing unit 142 is an API group of APIs for using a function (e.g., a function of acquiring a list of image files), which is related to acquisition of metadata that can be used by the specific external storage system 30.

Therefore, the common I/F 1421 is similarly defined for all the external service cooperating units 140. On the other hand, the unique I/F 1422 is defined for the external service cooperating unit 140 corresponding to the specific external storage system 30, in which the API defined by the unique I/F 1422 can be used.

As described above, the service providing system 10 according to the present embodiment includes the external service cooperating units 140 respectively corresponding to the external storage systems 30, which respectively perform processes in cooperation with the service providing system 10. Therefore, in a case where the external storage system 30 to be the cooperation destination is added or deleted (hereinafter, referred to as an “addition, etc.”), the external service cooperating unit 140, which corresponds to the external storage system 30 to be added, is to be added to the service providing system 10.

Therefore, in the service providing system 10 according to the present embodiment, the influence caused by the addition, etc., of the external storage system 30, which is to be the cooperation destination, can be localized. That is, in the service providing system 10 according to the present embodiment, the addition, etc., of the external storage system 30, which is to be the cooperation destination, can be done without influencing the other functional units (i.e., the input output service processing unit 110 and the document service unit 130, etc.). Note that the addition, etc., of the external service cooperating unit 140 may be performed by using a Software Development Kit (SDK).

Furthermore, the file processing unit 141 of the external service cooperating unit 140 defines the common I/F 1411 and the unique I/F 1412 by different modules, etc. Furthermore, the API defined by the common I/F 1411 and the unique I/F 1412 may be used by specifying an “external storage name” (a name of a storage service provided by the external storage system 30). That is, in the API defined by the common I/F 1411 and the unique I/F 1412, the “external storage name” is the variable part.

Therefore, when adding the external service cooperating unit 140, the common I/F 1411 defined in the file processing unit 141 of another external service cooperating unit 140 can be reused. That is, when adding the external service cooperating unit 140, the file processing unit 141 of the external service cooperating unit 140 to be added only needs to develop the unique I/F 1412. Note that the same applies with respect to the common I/F 1421 and the unique I/F 1422.

The application information storage unit 150 stores the application information 1000. The application information 1000 is stored in the application information storage unit 150, in association with an application ID for identifying the application information 1000. Note that the application information 1000 may also be associated with the name of the application information 1000 (application name).

Here, the application information 1000 includes the process flow information 1100. For example, the application information 1000 for providing the “OCR delivery A” service includes the process flow information 1100 in which a sequence of processes for implementing this service is defined. That is, the application information 1000 for providing the “OCR delivery A” service includes the process flow information 1100 defining a process of performing an OCR process on an electronic file generating by a scanning process, and then storing (uploading) the electronic file in the external storage system 30₁. Note that the application information 1000 may include two or more process flow information items 1100.

As described above, the process flow information 1100 is information defining a sequence of processes (process flow) for implementing a service provided according to the application information 1000. Note that details of the process flow information 1100 are described below.

The screen information storage unit 160 stores the screen information 2000. The screen information 2000 is stored in the screen information storage unit 160, in association with an application ID. Note that details of the screen information 2000 are described below.

Note that the input output service processing unit 110, the web service processing unit 120, the document service unit 130, the external service cooperating unit 140, the application information storage unit 150, and the screen information storage unit 160 may be respectively implemented by different information processing apparatuses.

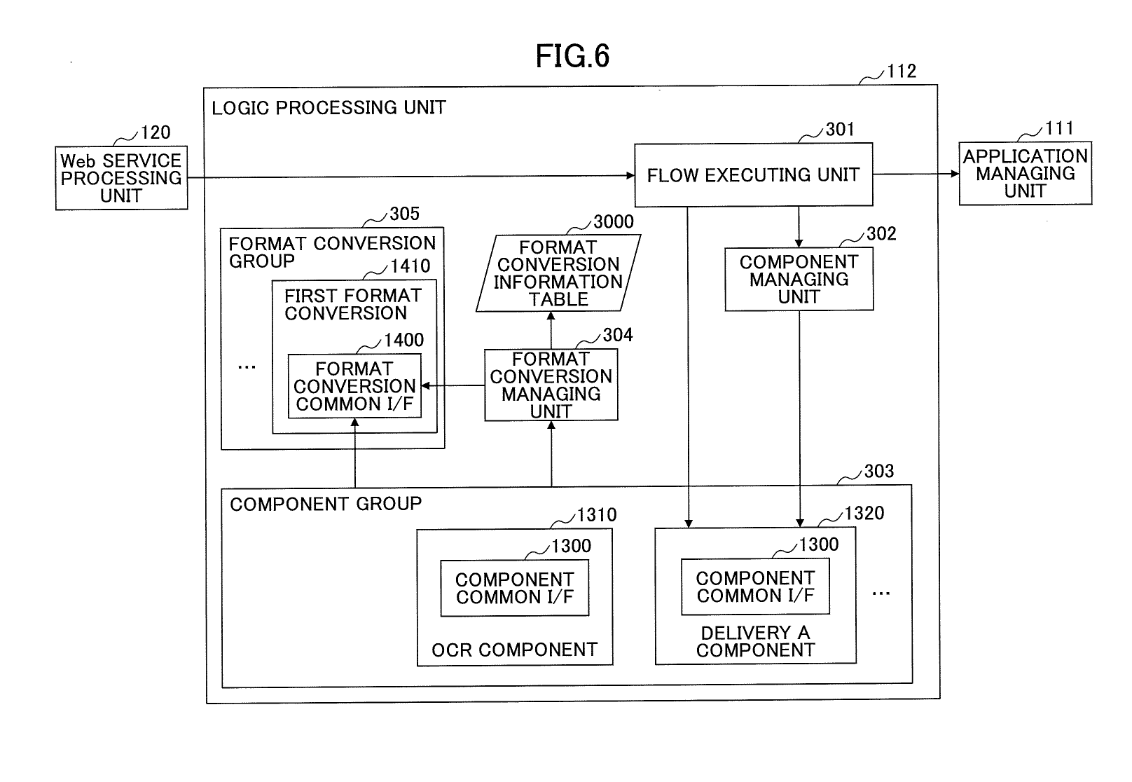

Here, a description is given of details of the functional configuration of the logic processing unit 112, by referring to FIG. 6. FIG. 6 illustrates a functional configuration of an example of the logic processing unit 112 according to the present embodiment.

The logic processing unit 112 illustrated in FIG. 6 includes a flow executing unit 301, a component managing unit 302, a component group 303, a format conversion managing unit 304, and a format conversion group 305. Furthermore, the logic processing unit 112 includes a format conversion information table 3000.

When the flow executing unit 301 receives a process flow execution request from the web service processing unit 120, the flow executing unit 301 acquires, from the application managing unit 111, the process flow information 1100 corresponding to the execution request. Then, the flow executing unit 301 executes a sequence of processes (process flow) based on the process flow information 1100 acquired from the application managing unit 111.

At this time, the flow executing unit 301 provisionally executes the sequence of processes (process flow) based on the process flow information 1100, and when an error, etc., does not occur in the provisional execution, the flow executing unit 301 formally executes the sequence of processes (process flow).

Here, provisional execution means to execute the sequence of processes in order to confirm the formalities of the processes included in the sequence of processes, before formally executing the sequence of processes (process flow) based on the process flow information 1100. On the other hand, formal execution means to execute the sequence of processes for implementing a service provided according to the application information 1000, when formalities of the processes, included in the sequence of processes (process flow) based on the process flow information 1100, have been confirmed.

Furthermore, a sequence of processes based on the process flow information 1100 is executed by combining components for executing the processes included in the sequence of processes. Note that confirming the formalities of the processes included in the sequence of processes means, for example, to confirm the compatibility of parameter information with respect to the components for executing the processes, etc. Note that a component is implemented by programs and modules, etc., for executing processes for implementing a predetermined function, and a component is defined by, for example, a class and a function, etc.

The component managing unit 302 manages components. The component managing unit 302 generates a component and returns the generated component to the flow executing unit 301, in response to a request from the flow executing unit 301. Note that generating a component means loading a component defined by, for example, a class and a function, etc., in a memory (for example, the RAM 14).

The component group 303 is an assembly of components. The component group 303 includes an OCR component 1310 and a delivery A component 1320.

The OCR component 1310 is a component for performing an OCR process on an electronic file. The OCR component 1310 requests the OCR processing unit 131 of the document service unit 130 to execute an OCR process, in order to perform an OCR process on an electronic file.

The delivery A component 1320 is a component for storing (uploading) an electronic file in the external storage system 30₁ (storage A). The delivery A component 1320 uploads an electronic file, by requesting the file processing unit 141 of the external service cooperating unit 140₁ corresponding to the external storage system 30₁, to upload an electronic file.

Note that the component group 303 also includes various components such as a conversion component for converting the data format of an electronic file into a predetermined data format, and a compression component for compressing an electronic file, etc., other than the above components. Furthermore, the component group 303 includes, for example, a delivery B component for storing (uploading) an electronic file in the external storage system 30₂ (storage B). Furthermore, the component group 303 includes, for example, an acquisition A component for acquiring (downloading) an electronic file from the external storage system 30₁ (storage A).

As described above, the component group 303 includes various components for executing processes for implementing predetermined functions.

Furthermore, each component included in the component group 303 includes a component common I/F 1300. The component common I/F 1300 is an API that is commonly defined for the components, and includes an API for generating a component and an API for requesting to execute a process of the component.

As described above, the components include the component common I/F 1300, and therefore the influence caused by the addition, etc., of a component can be localized. That is, for example, the addition, etc., of a component can be performed without influencing the flow executing unit 301 or the component managing unit 302, etc. Accordingly, in the service providing system 10 according to the present embodiment, the development labor hours associated with the addition, etc., of a predetermined function, etc., (that is, the addition, etc., of a component for executing processes for implementing the function) can be reduced.

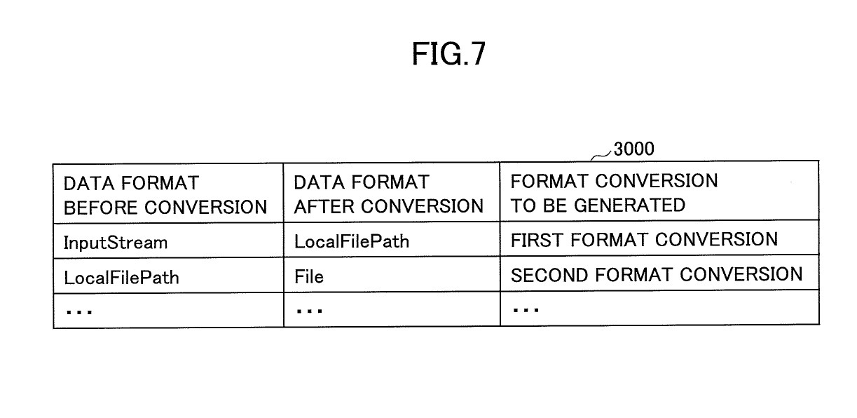

The format conversion managing unit 304 manages the format conversion of the data format. Here, the data format that each component can handle is defined in advance. Therefore, in response to a request from a component, the format conversion managing unit 304 refers to the format conversion information table 3000, for example, as illustrated in FIG. 7, and generates a format conversion to be included in the format conversion group 305.

Then, the format conversion managing unit 304 requests the generated format conversion to execute a format conversion process. Note that format conversion is a program and a module, etc. for executing a format conversion process of converting the data format, and is defined by, for example, a class and a function, etc. Furthermore, the generation of format conversion means, for example, to load the format conversion defined by a class, in a memory (for example, the RAM 14).

Note that examples of data formats are a data format “InputStream” indicating stream data, “LocalFilePath” indicating the path (address) of the electronic file stored in a storage device, etc., and “File” indicating the entity of an electronic file, etc.

Here, a description is given of the format conversion information table 3000, by referring to FIG. 7. FIG. 7 illustrates an example of the format conversion information table 3000.

The format conversion information table 3000 illustrated in FIG. 7 includes the data items of a data format before conversion, a data format after conversion, and a conversion format conversion to be generated. That is, the format conversion information stored in the format conversion information table 3000 is information in which a format conversion, which is for converting a data format before conversion into a data format after conversion, is associated with each data format before conversion and each data format after conversion.

The format conversion group 305 is an assembly of format conversions. The format conversion group 305 includes a first format conversion 1410 for converting the data format “InputStream” into “LocalFilePath”. Note that the format conversion group 305 also includes a second format conversion for converting the data format “LocalFilePath” into “File”, etc.

Furthermore, each format conversion included in the format conversion group 305 includes a format conversion common I/F 1400. The format conversion common I/F 1400 is an API that is commonly defined for the format conversions. The format conversion common I/F 1400 includes an API for generating a format conversion and an API for executing a format conversion process of the format conversion.

As described above, each format conversion includes the format conversion common I/F 1400, and therefore the influence caused by the addition, etc., of a format conversion can be localized. That is, for example, the addition, etc., of a format conversion can be performed without influencing the format conversion managing unit 304, etc. Accordingly, in the service providing system 10 according to the present embodiment, the development labor hours associated with the addition, etc., of a format conversion can be reduced.

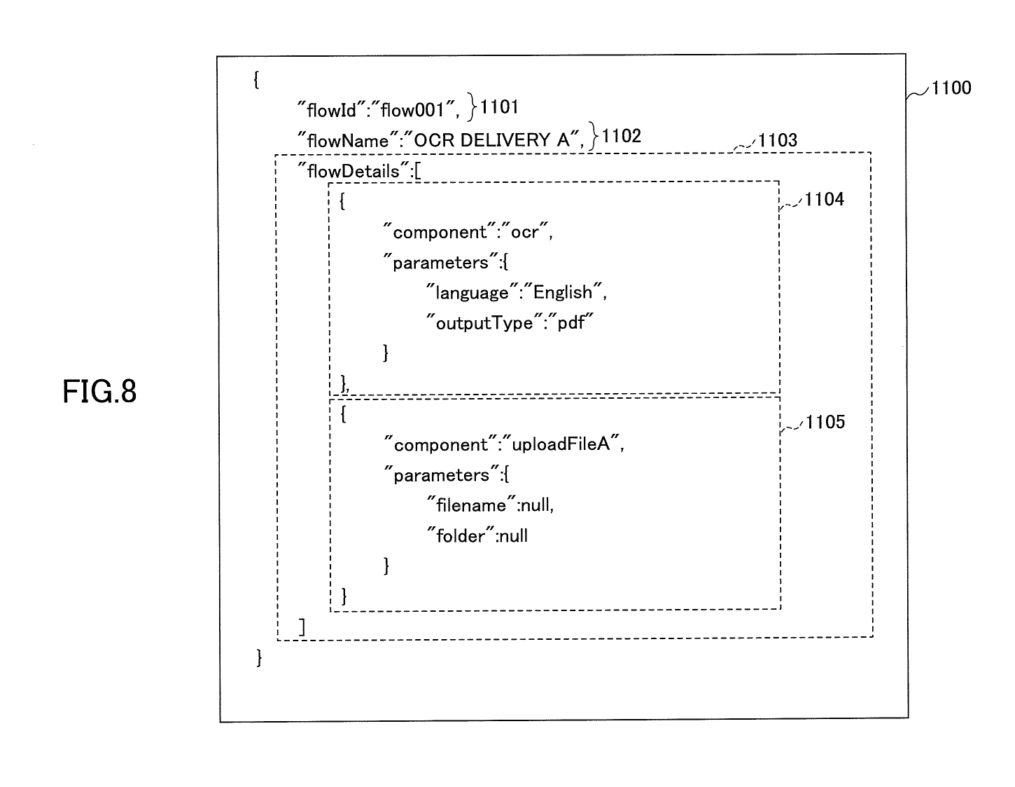

Here, a description is given of the process flow information 1100 included in the application information 1000 for providing the “OCR delivery A” service, by referring to FIG. 8. FIG. 8 illustrates an example of the process flow information 1100 in which a sequence of processes for implementing the “OCR delivery A” service is defined.

The process flow information 1100 illustrated in FIG. 8 is information in which a sequence of processes (process flow) for implementing the “OCR delivery A” service is defined.

The process flow information 1100 illustrated in FIG. 8 includes a flow ID 1101 for identifying the process flow information 1100 and a flow name 1102 indicating the name of the sequence of processes (process flow) based on the process flow information 1100. Furthermore, the process flow information 1100 illustrated in FIG. 8 includes flow details 1103 in which process contents of the processes included in the sequence of processes (process flow) are defined.

The flow details 1103 include a process definition 1104 and a process definition 1105 defining the respective processes included in the process flow. Furthermore, the process definition 1104 and the process definition 1105 include “component” indicating the component name of the component executing the process and “parameters” defining the parameter information with respect to the component.

Specifically, at “component” in the process definition 1104, the component name “ocr” of the OCR component 1310 is defined. Furthermore, at “parameters” in the process definition 1104, the parameter information of the parameter name “language” and the parameter information of the parameter name “outputType” are defined.

Furthermore, in the parameter information of the parameter name “language”, “English”, which indicates that the language of the OCR process is English, is defined as a parameter value. Similarly, in the parameter information of the parameter name “outputType”, “pdf”, which indicates that the file format after the OCR process is a PDF format, is defined as a parameter value.

Similarly, at “component” in the process definition 1105, the component name “uploadFileA” of the delivery A component 1320 is defined. Furthermore, at “parameters” in the process definition 1105, the parameter information of the parameter name “filename” and the parameter information of the parameter name “folder” are defined.

Furthermore, in the parameter information of the parameter name “filename”, “null”, which indicates that the name (file name) of the electronic file to be uploaded is not set, is defined as a parameter value. Similarly, in the parameter information of the parameter name “folder”, “null”, which indicates that the upload destination (storage destination) folder is not set, is defined as a parameter value.

As described above, in the process flow information 1100, the process definitions of the respective processes forming the sequence of processes (process flow) are defined. Accordingly, the service providing system 10 according to the present embodiment can execute a sequence of processes for implementing a service provided according to the application information 1000, by performing processes by the respective components according to the process definitions included in the process flow information 1100.

Note that the processes defined in the process definitions included in the process flow information 1100 illustrated in FIG. 8 are executed in an order starting from the top process. That is, the processes in a sequence of processes based on the process flow information 1100 in FIG. 8 are executed in the order of the process defined in the process definition 1104 and the process defined in the process definition 1105. However, the order of executing the processes is not limited as such; for example, the process flow information 1100 may include information defining the order of executing the processes defined in each process definition.

### <Process Details>

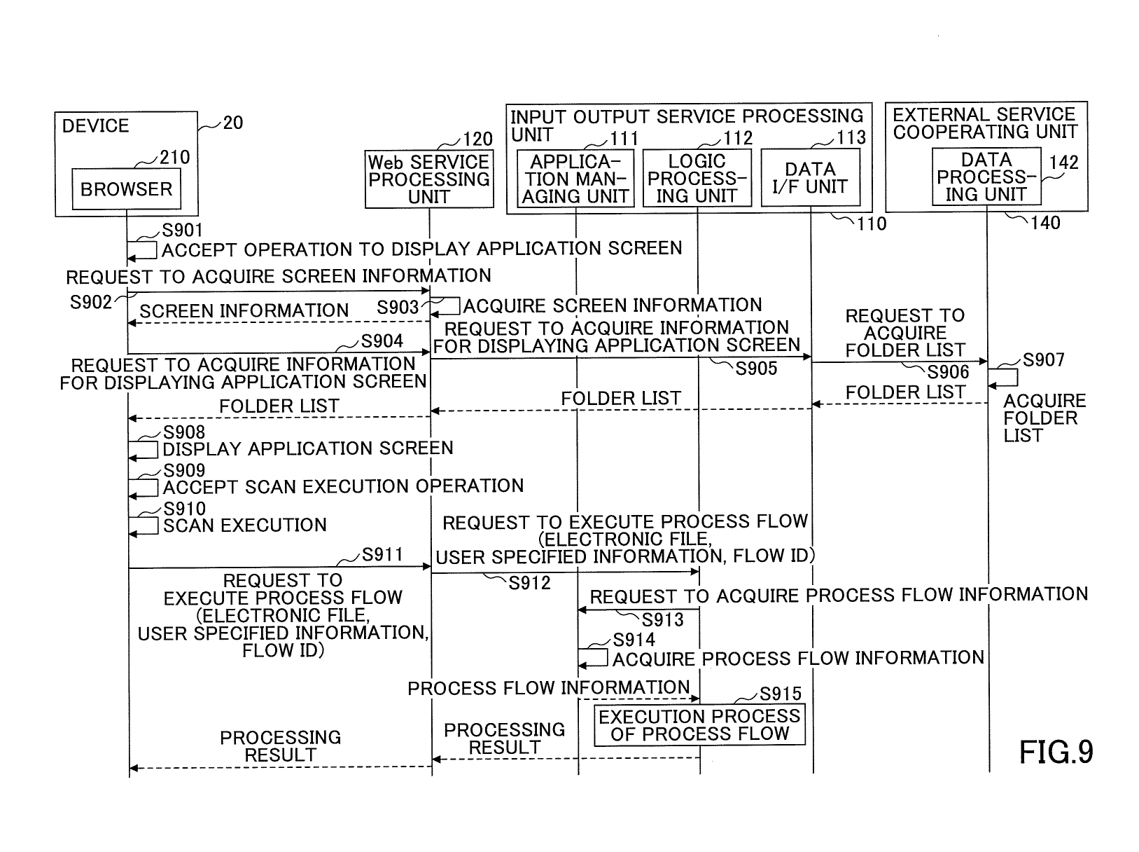

Next, a description is given of details of processes by the information processing system 1 according to the present embodiment. In the following, a description is given of the overall process in a case where a user of the device 20 uses the “OCR delivery A” service, by referring to FIG. 9. FIG. 9 is a sequence diagram of an example of the overall process of the “OCR delivery A” service according to the present embodiment.

First, the browser 210 of the device 20 accepts an operation (display operation) for displaying an application screen of the “OCR delivery A” service (step S901).

When the browser 210 of the device 20 accepts the display operation, the browser 210 sends a request to acquire screen information for displaying an application screen of the “OCR delivery A” service, to the web service processing unit 120 (step S902). Note that this acquisition request is, for example, a Hypertext Transfer Protocol (HTTP) request, and a Uniform Resource Locator (URL) of the application information 1000 providing the “OCR delivery A” service is specified. At this time, the acquisition request may include the application ID of the application information 1000 for providing the “OCR delivery A” service.

When the web service processing unit 120 receives the request to acquire screen information, the web service processing unit 120 acquires, from the screen information storage unit 160, the screen information 2000 associated with the application ID corresponding to the URL specified in the acquisition request (step S903). Then, the web service processing unit 120 returns the screen information 2000 acquired from the screen information storage unit 160, to the browser 210. That is, the browser 210 returns a HTTP response including the screen information 2000 acquired from the screen information storage unit 160, to the browser 210.

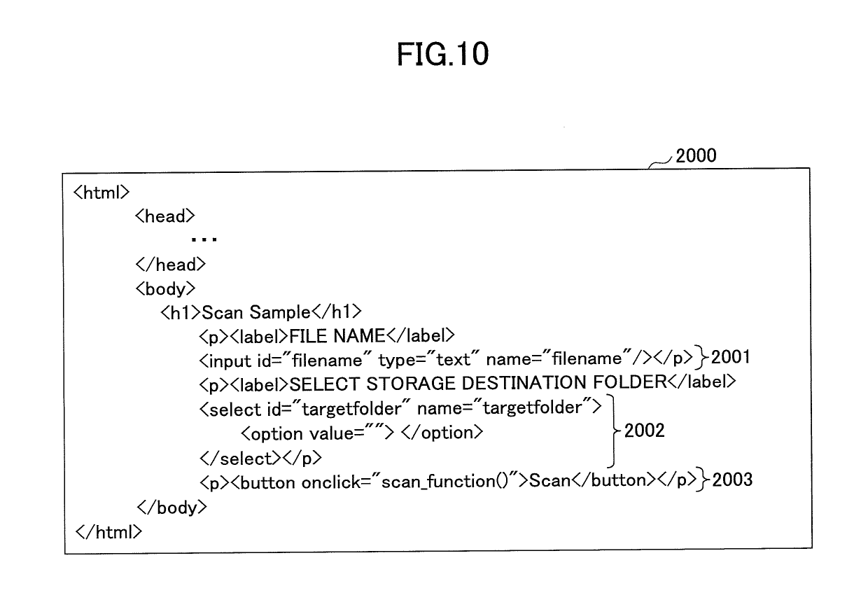

Here, a description is given of the screen information 2000 for displaying an application screen of the “OCR delivery A” service, by referring to FIG. 10. FIG. 10 illustrates an example of the screen information 2000 for displaying an application screen of the “OCR delivery A” service.

The screen information 2000 illustrated in FIG. 10 is information defined in a HTML format. The screen information 2000 illustrated in FIG. 10 includes a INPUT tag 2001 for displaying a text box for inputting a file name, a SELECT tag 2002 for displaying a field for selecting the storage destination folder, and a BUTTON tag 2003 for displaying a button for executing scanning.

Accordingly, as described below, the information of the folders included in the folder list acquired from the external storage system 30₁, is defined as selection elements in the SELECT tag 2002, to display an application screen for using the “OCR delivery A” service.

When the browser 210 of the web service processing unit 120 receives the screen information 2000, the browser 210 sends a request to acquire information for displaying an application screen, to the web service processing unit 120 (step S904).

Note that information for displaying an application screen includes the selection elements to be included in the selection field of the application screen. In the present embodiment, a folder list including candidates of storage destination folders of an electronic file in the “OCR delivery A” service, is acquired as a selection element from the external storage system 30₁ (storage A).

When the web service processing unit 120 receives the request to acquire the information for displaying an application screen, the web service processing unit 120 sends the acquisition request to the data I/F unit 113 (step S905).

When the data I/F unit 113 receives the request to acquire the information for displaying an application screen, the data I/F unit 113 sends a request to acquire a folder list of folders in the storage A, to the data processing unit 142 of the external service cooperating unit 140 (step S906).

Note that the data I/F unit 113 sends the request to acquire a folder list to the data processing unit 142 of the external service cooperating unit 140₁ corresponding to the storage A (external storage system 30₁). That is, for example, the data I/F unit 113 uses the API defined in the common I/F 1421 as “storageA/data/folders”, to send the request to acquire the folder list.

When the data processing unit 142 of the external service cooperating unit 140 receives the request to acquire a folder list, the data processing unit 142 sends the request to acquire a folder list to the external storage system 30, to acquire the folder list (step S907). Then, the data processing unit 142 returns the acquired folder list to the browser 210, via the data I/F unit 113 and the web service processing unit 120.

When the browser 210 of the device 20 receives the folder list, the browser 210 displays an application screen on the operation panel 22, based on the received folder list and the screen information 2000 returned in step S903 (step S908). That is, for example, the browser 210 defines the folder IDs included in the folder list as values (VALUES) in the OPTION tag, in the SELECT tag 2002 in the screen information 2000 of FIG. 10, and displays the application screen based on the screen information 2000.

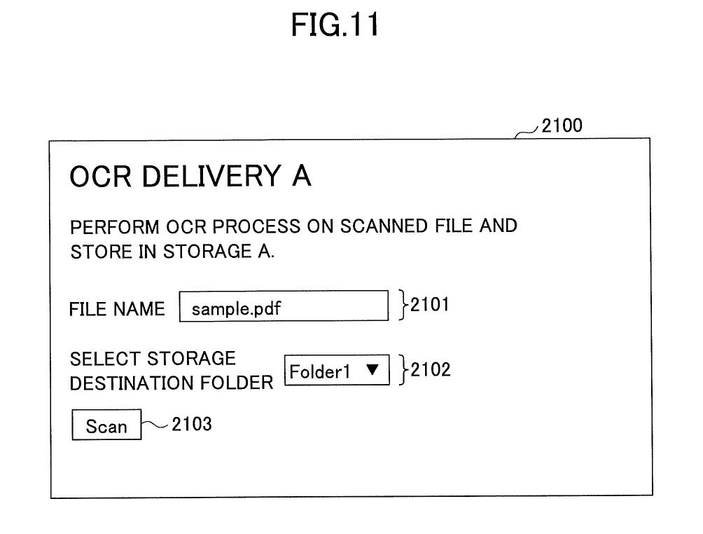

Accordingly, the browser 210 displays an application screen 2100, for example, as illustrated in FIG. 11, on the operation panel 22 of the device 20. FIG. 11 illustrates an example of the application screen 2100 for using the “OCR delivery A” service.

The application screen 2100 illustrated in FIG. 11 is a screen for using the “OCR delivery A” service. The application screen 2100 illustrated in FIG. 11 includes a text box 2101 for inputting a file name of the electronic file to be uploaded in the storage A, and a selection field 2102 for selecting the storage destination folder in the storage A. Furthermore, the application screen 2100 illustrated in FIG. 11 includes a scan button 2103 for executing scanning.

Note that the text box 2101, the selection field 2102, and the scan button 2103 are displayed as the browser 210 respectively interprets the INPUT tag 2001, the SELECT tag 2002, and the BUTTON tag 2003.

As described above, the service providing system 10 according to the present embodiment returns the screen information 2000 that is defined in a format that is interpretable by the browser 210, such as the HTML format, etc., in response to a request from the browser 210 of the device 20. Then, the device 20 displays the application screen 2100 for using the service, based on the screen information 2000 returned from the service providing system 10. Therefore, the user is able to use a service provided by the service providing system 10, by using the device 20 in which the general-purpose browser 210 is installed.

When a file name is input in the text box 2101, a storage destination folder is selected from the selection field 2102, and the scan button 2103 is pressed, the browser 210 of the device 20 accepts user specified information and a scan execution operation (step S909). Note that user specified information is the file name specified in the text box 2101 and the folder ID of the storage destination folder specified in the selection field 2102.

For example, it is assumed that “sample.pdf” is specified in the text box 2101 and “Folder1” (folder ID “folder1”) is specified in the selection field 2102. In this case, the user specified information includes, for example, “filename”:“sample.pdf” and “folder”:“folder1”.

When the browser 210 of the device 20 accepts the scan execution operation, the scanner 26 reads an original document and generates an electronic file (image file) (step S910).

Next, when the electronic file is generated, the browser 210 of the device 20 sends a request to execute a process flow to the web service processing unit 120 (step S911). Note that the execution request is, for example, a HTTP request. The execution request includes the flow ID of the process flow information 1100 in which the sequence of processes for implementing the “OCR delivery A” service is defined, the electronic file generated in step S910, and the user specified information.

However, the request to execute the process flow may include, for example, the URL of the application information 1000, the screen ID of the application screen 2100 displayed in step S908, and the button ID of the scan button 2103, etc., instead of the flow ID. That is, the request to execute the process flow may include various types of identification information, which can be converted into a flow ID in step S912 described below, instead of the flow ID.

When the web service processing unit 120 receives the request to execute the process flow, the web service processing unit 120 sends this request to the logic processing unit 112 of the input output service processing unit 110 (step S912). Note that for example, when the URL of the application information 1000, the screen ID of the application screen 2100, and the button ID of the scan button 2103, etc., are included in the request to execute the process flow, the web service processing unit 120 converts this identification information into a flow ID.

Next, when the logic processing unit 112 of the input output service processing unit 110 receives the request to execute the process flow, the flow executing unit 301 sends a request to acquire process flow information to the application managing unit 111 (step S913). Note that this acquisition request includes the flow ID.

When the application managing unit 111 receives the acquisition request for the process flow information, the application managing unit 111 acquires the process flow information 1100 identified by the flow ID included in the acquisition request, from the application information storage unit 150 (step S914).

Then, the application managing unit 111 returns the process flow information 1100, which has been acquired from the application information storage unit 150, to the logic processing unit 112. In the following description, it is assumed that the application managing unit 111 has returned the process flow information 1100 illustrated in FIG. 8, to the logic processing unit 112.

Next, when the logic processing unit 112 receives the process flow information 1100 from the application managing unit 111, the logic processing unit 112 performs a process of executing the process flow based on the process flow information 1100 (step S915).

That is, the logic processing unit 112 performs a process of executing the sequence of processes (process flow) for implementing the “OCR delivery A” service. At this time, the logic processing unit 112 provisionally executes the sequence of processes (process flow) for implementing the “OCR delivery A” service, and when an error, etc., does not occur in the provisional execution, the logic processing unit 112 formally executes the sequence of processes (process flow), to perform the process of executing the process flow. Note that details of the execution process of the process flow are described below.

Then, the logic processing unit 112 returns the processing result of the execution process of the process flow to the browser 210, via the web service processing unit 120. Accordingly, the service providing system 10 according to the present, embodiment can provide various kinds of services (for example, the “OCR delivery A” service) implemented by the sequence of processes (process flow) based on the process flow information 1100.

Note that in the overall process of the “OCR delivery A” service of FIG. 9, the browser 210 sends the request to execute the process flow to the logic processing unit 112 via the web service processing unit 120; however, the present embodiment is not limited as such. For example, the browser 210 may call a Web API based on JavaScript, etc., defined in the screen information 2000, to directly send the request to execute the process flow to the logic processing unit 112, without involving the web service processing unit 120.

In the following, a detailed description is given of the process of executing the process flow for implementing the “OCR delivery A” service (the process of step S915 in FIG. 9). Note that in the process of executing the process flow, as described above, a sequence of processes (process flow) for implementing the “OCR delivery A” service is provisionally executed, and when an error, etc., does not occur in the provisional execution, the sequence of processes (process flow) is formally executed. Therefore, in the following, in the process of executing the process flow in step S915 of FIG. 9, the stage of provisionally executing the sequence of processes is also referred to as a “provisional execution phase”, and the stage of formally executing the sequence of processes is also referred to as a “formal execution phase”.

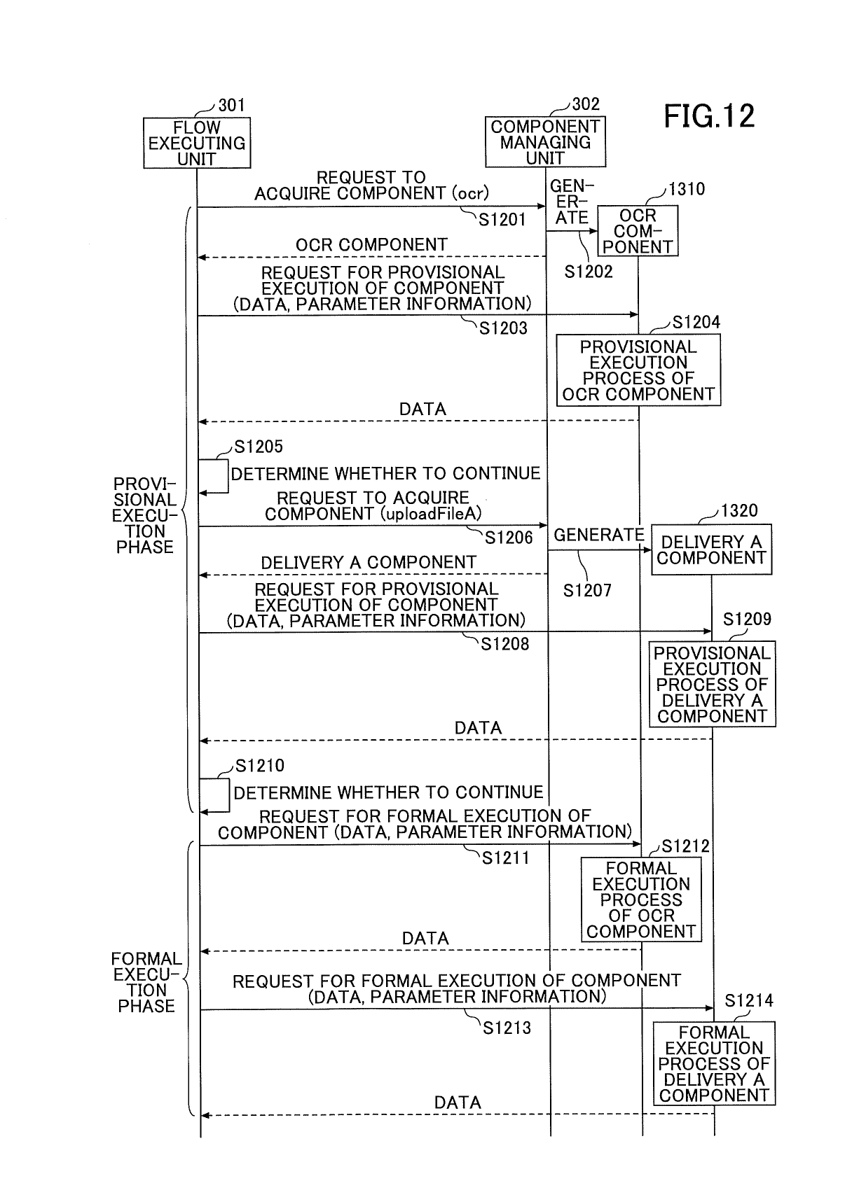

First, a description is given of a case where the provisional execution phase is successfully ended, and subsequently, the formal execution phase is performed, in the process of executing the process flow for implementing the “OCR delivery A” service, by referring to FIG. 12. FIG. 12 is a sequence diagram of an example of the process of executing the process flow according to the present embodiment.

First, the flow executing unit 301 sends a request to acquire a component to the component managing unit 302, based on the process flow information 1100 returned from the application managing unit 111 in step S914 of FIG. 9 (step S1201). That is, the flow executing unit 301 sends, to the component managing unit 302, a request to acquire a component including “ocr” defined at “component” in the process definition 1104 in the process flow information 1100 of FIG. 8.

When the component managing unit 302 receives the request to acquire a component, the component managing unit 302 generates the OCR component 1310 corresponding to “ocr” included in the acquisition request (step S1202). Note that the OCR component 1310 can be generated by using the component common I/F 1300.

Then, the component managing unit 302 returns the generated OCR component 1310 to the flow executing unit 301. That is, for example, the component managing unit 302 returns an address in a memory (for example, the RAM 14) in which the OCR component 1310 is loaded, to the flow executing unit 301.

When the flow executing unit 301 receives the returned OCR component 1310, the flow executing unit 301 sends a request to provisionally execute the component, to the OCR component 1310 (step S1203). Note that the request to provisionally execute the component is a request to provisionally execute the OCR component 1310, and this request includes data and parameter information.

Here, in step S1203 described above, the data is the electronic file received from the web service processing unit 120 (the electronic file included in the request to execute the process flow), having a data format “InputStream”. That is, the flow executing unit 301 sends the electronic file received from the web service processing unit 120 simply as “data” (without considering the data format), to the OCR component 1310. In the present embodiment, electronic files, etc., for which the data format is not considered as described above, are simply referred to as “data”.

Furthermore, in step S1203 described above, the parameter information is each of the parameter information items defined at “parameters” in the process definition 1104 in the process flow information 1100 of FIG. 8. That is, the request to execute the process of the component at step S1203 described above includes parameter information “language”:“English” and parameter information “outputType”:“pdf”.

When the OCR component 1310 receives the request to provisionally execute the component, the OCR component 1310 uses the data and the parameter information included in the provisional execution request, to perform the provisional execution (step S1204).

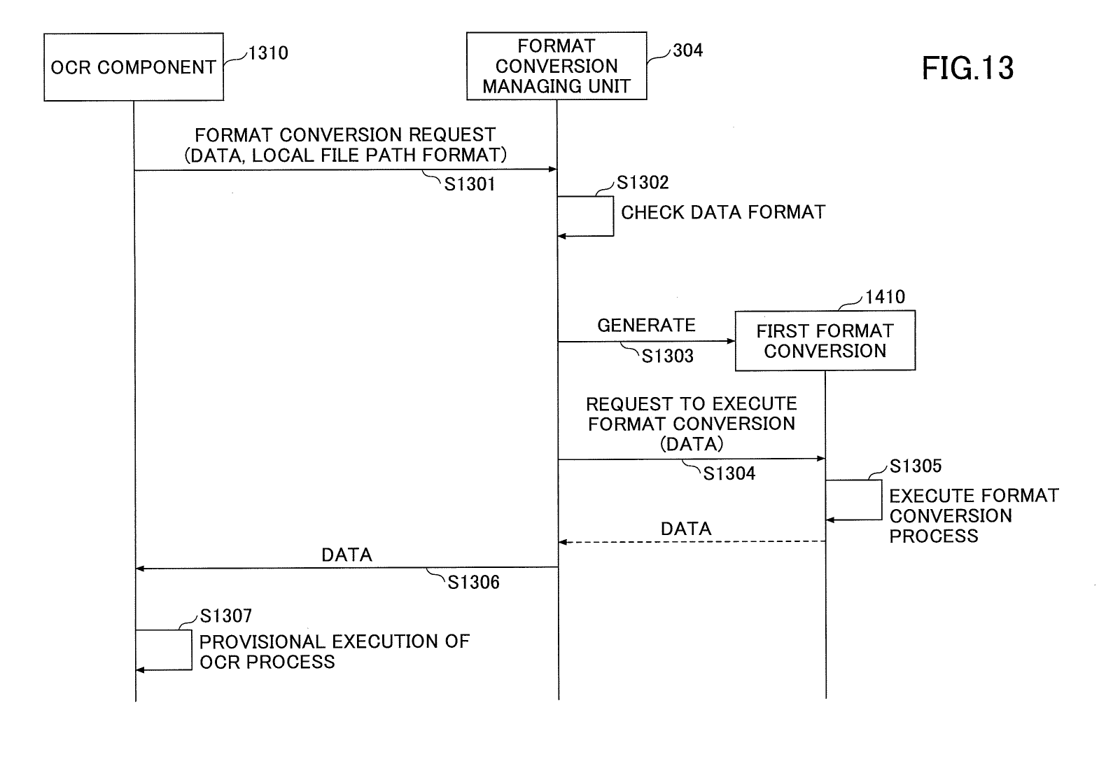

Here, a description is given of the process of provisionally executing the OCR component 1310, by referring to FIG. 13. FIG. 13 is a sequence diagram of an example of a process of provisionally executing the OCR component 1310 according to the present embodiment.

The OCR component 1310 sends a format conversion request to the format conversion managing unit 304 (step S1301). Note that the format conversion request includes data and a specification of “LocalFilePath” indicating the data format that can be handled by the OCR component 1310.

When the format conversion managing unit 304 receives the format conversion request, the format conversion managing unit 304 checks whether the data format of the data included in the format conversion request and the specified data format match each other (step S1302).

Here, the data format of the data included in the format conversion request is “InputStream”, while the specified data format is “LocalFilePath”. Therefore, the format conversion managing unit 304 determines that the data format of the data included in the format conversion request and the specified data format do not match each other.

Then, the format conversion managing unit 304 refers to the format conversion information table 3000 illustrated in FIG. 7, and identifies the format conversion for converting the data format “InputStream” to “LocalFilePath” (here, the first format conversion 1410 is identified). Then, the format conversion managing unit 304 generates the identified first format conversion 1410 (step S1303). Note that the first format conversion 1410 may be generated by using the format conversion common I/F 1400.

Next, the format conversion managing unit 304 sends a request to execute a format conversion process to the first format conversion 1410 (step S1304). Note that the execution request includes data.

When the first format conversion 1410 receives the request to execute format conversion, the first format conversion 1410 performs a format conversion process of converting the data format of the data included in the execution request, from “InputStream” to “LocalFilePath” (step S1305). Then, the first format conversion 1410 returns the data for which the data format has been converted, to the format conversion managing unit 304.

Then, when the format conversion managing unit 304 receives the data from the first format conversion 1410, the format conversion managing unit 304 sends the data to the OCR component 1310 (step S1306).

When the OCR component 1310 receives the data from the format conversion managing unit 304, the OCR component 1310 uses the data and the parameter information to perform a process of provisionally executing an OCR process (step S1307).

Here, for example, the OCR component 1310 checks the data and checks the parameter information, etc., as the process of provisionally executing an OCR process. That is, for example, the OCR component 1310 performs the data check by checking whether the number of pages, the number of files, and the size, etc., of the electronic file indicated by the data (data format “LocalFilePath”) exceed the upper limit that is set in advance. Furthermore, for example, the OCR component 1310 performs the parameter information check by checking whether the OCR language (the parameter value of the parameter information “language”) and the output data format (the parameter value of the parameter information “outputType”) are supported, etc.

Note that the OCR component 1310 may change the data, which is received from the flow executing unit 301, into lighter data (data of a smaller size), and use the changed data to perform the OCR process. Furthermore, the OCR component 1310 may store the result obtained by performing an OCR process by using the light data (that is, the electronic file obtained by performing an OCR process on the electronic file indicated by the light data), and use this stored data in the formal execution process.

As described above, the OCR component 1310 performs a provisional execution process such as data check and parameter information check, etc.

Then, the OCR component 1310 returns data indicating the processing result of the provisional execution, to the flow executing unit 301. Here, for example, when the OCR component 1310 determines, by the data check, that the number of pages, the number of files, and the size, etc., of the electronic file exceed the upper limit that is set in advance, the OCR component 1310 returns data indicating that an error has occurred, to the flow executing unit 301. Similarly, for example, when the OCR component 1310 determines, by the parameter information check, that the OCR language and the output data format specified by the parameter values are not supported, the OCR component 1310 returns data indicating that an error has occurred, to the flow executing unit 301.

Referring back to FIG. 12, when the flow executing unit 301 receives data from the OCR component 1310, the flow executing unit 301 determines whether to continue the process of executing the process flow (step S1205). That is, the flow executing unit 301 determines whether the data returned from the OCR component 1310 indicates that an error, etc., has occurred.

Here, in step S1205 described above, when the flow executing unit 301 determines that the data returned from the OCR component 1310 indicates that an error, etc., has occurred, the flow executing unit 301 reports to the device 20 that an error, etc., has occurred, and ends the process. Conversely, when the flow executing unit 301 determines that the data returned from the OCR component 1310 does not indicate that an error, etc., has occurred, the flow executing unit 301 continues the process. The following description is continued assuming that the flow executing unit 301 has determined that the data returned from the OCR component 1310 does not indicate that an error, etc., has occurred.

The flow executing unit 301 sends a request to acquire a component to the component managing unit 302, based on the process flow information 1100 returned from the application managing unit 111 in step S914 in FIG. 9 (step S1206). That is, the flow executing unit 301 sends, to the component managing unit 302, a request to acquire a component including “uploadFileA” defined in “component” in the process definition 1105 in the process flow information 1100 of FIG. 8.

When the component managing unit 302 receives the request to acquire a component, the component managing unit 302 generates the delivery A component 1320 corresponding to “uploadFileA” included in the acquisition request (step S1207). Note that the delivery A component 1320 may be generated by using the component common I/F 1300.

Then, the component managing unit 302 returns the generated delivery A component 1320 to the flow executing unit 301. That is, for example, the component managing unit 302 returns an address in a memory (for example, the RAM 14) in which the delivery A component 1320 is loaded, to the flow executing unit 301.

When the flow executing unit 301 receives the returned delivery A component 1320, the flow executing unit 301 sends a request to provisionally execute the component, to the delivery A component 1320 (step S1208). Note that the request to provisionally execute the component is a request to provisionally execute the delivery A component 1320, and this request includes data and parameter information.

Here, in step S1208 described above, the data is the data returned from the OCR component 1310.

Furthermore, in step S1208 described above, the parameter information is each of the parameter information items defined at “parameters” in the process definition 1105 in the process flow information 1100 of FIG. 8.

That is, the request to provisionally execute the component in step S1208 described above includes parameter information “filename”:null and parameter information “folder”:null. Furthermore, the request to provisionally execute the component in step S1208 described above includes user specified information “filename”:“sample.pdf” and user specified information “folder”:“folder1” received from the web service processing unit 120.

When the delivery A component 1320 receives the request to provisionally execute the component, the delivery A component 1320 uses the data, the parameter information, and the user specified information included in the provisional execution request, to perform the provisional execution (step S1209).

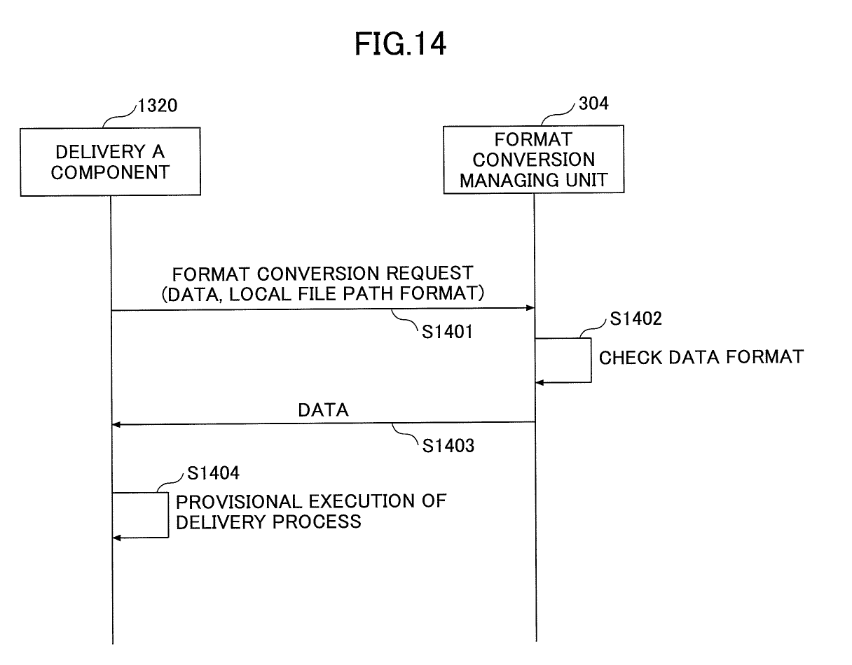

Here, a description is given of the process of provisionally executing the delivery A component 1320, by referring to FIG. 14. FIG. 14 is a sequence diagram of an example of a process of provisionally executing the delivery A component 1320 according to the present embodiment.

When the delivery A component 1320 receives the request to provisionally execute the component, the delivery A component 1320 sends a format conversion request to the format conversion managing unit 304 (step S1401). Note that the format conversion request includes data and a specification of “LocalFilePath” indicating the data format that can be handled by the delivery A component 1320.

When the format conversion managing unit 304 receives the format conversion request, the format conversion managing unit 304 checks whether the data format of the data included in the format conversion request and the specified data format match each other (step S1402).

Here, the data format of the data included in the format conversion request is “LocalFilePath”, and the specified data format is also “LocalFilePath”. Therefore, the format conversion managing unit 304 determines that the data format of the data included in the format conversion request and the specified data format match each other.

Then, the format conversion managing unit 304 sends the data included in the format conversion request, to the delivery A component 1320 (step S1403). As described above, when the format conversion managing unit 304 determines, in the process of checking the data format (the process of step S1402), that the data format of the data and the specified data format match each other, the format conversion managing unit 304 does not generate format conversion.

When the delivery A component 1320 receives data from the format conversion managing unit 304, the delivery A component 1320 uses the data, the parameter information, and the user specified information to perform a process of provisionally executing an uploading process to the storage A (step S1404). At this time, the delivery A component 1320 defines the user specified information in the parameter information as “filename”:“sample.pdf” and “folder”:“folder1”.

Here, for example, the delivery A component 1320 checks the data and checks the parameter information, etc., as the process of provisionally executing an uploading process to the storage A. That is, for example, the delivery A component 1320 performs the data check by checking whether the number of pages, the number of files, and the size, etc., of the data (the electronic file indicated by the data format “LocalFilePath”) exceed the upper limit that is set in advance. Furthermore, for example, the delivery A component 1320 performs the parameter information check by checking whether the file name (the parameter value of parameter information “filename”) includes characters that cannot be used, etc. Furthermore, for example, the delivery A component 1320 performs the parameter information check by checking whether the storage destination folder (the parameter value of parameter information “folder”) exists, etc.

Note that, for example, the delivery A component 1320 may confirm the coupling status with respect to the external storage system 30₁ (confirm whether data communication is possible with the external storage system 30₁), as the process of provisionally executing the uploading process to the storage A. Furthermore, the delivery A component 1320 may change the data, which is received from the flow executing unit 301, into lighter data (data of a smaller size), and use the changed data to perform the process of provisionally executing the uploading process to the storage A. Furthermore, the delivery A component 1320 may store the light data, and use this stored data in the formal execution process.

As described above, the delivery A component 1320 performs a provisional execution process such as data check and parameter information check, etc.

Then, the delivery A component 1320 returns data indicating the processing result of the provisional execution, to the flow executing unit 301. Here, for example, when the delivery A component 1320 determines, by the data check, that the number of pages, the number of files, and the size, etc., of the electronic file exceed the upper limit that is set in advance, the delivery A component 1320 returns data indicating that an error has occurred, to the flow executing unit 301. Similarly, for example, when the delivery A component 1320 determines, by the parameter information check, that the file name specified in the parameter value includes characters that cannot be used, etc., the delivery A component 1320 returns data indicating that an error has occurred, to the flow executing unit 301. Furthermore, similarly, for example, when the delivery A component 1320 determines, by the parameter information check, that the storage destination folder specified in the parameter value does not exist, etc., the delivery A component 1320 returns data indicating that an error has occurred, to the flow executing unit 301.

Referring back to FIG. 12, when the flow executing unit 301 receives data from the delivery A component 1320, the flow executing unit 301 determines whether to continue the process of executing the process flow (step S1210). That is, the flow executing unit 301 determines whether the data returned from the delivery A component 1320 indicates that an error, etc., has occurred.

Here, in step S1210 described above, when the flow executing unit 301 determines that the data returned from the delivery A component 1320 indicates that an error, etc., has occurred, the flow executing unit 301 reports to the device 20 that an error, etc., has occurred, and ends the process. Conversely, when the flow executing unit 301 determines that the data returned from the delivery A component 1320 does not indicate that an error, etc., has occurred, the flow executing unit 301 continues the process. The following description is continued assuming that the flow executing unit 301 has determined that the data returned from the delivery A component 1320 does not indicate that an error, etc., has occurred.

The flow executing unit 301 sends a request to formally execute the component, to the OCR component 1310 (step S1211). Note that the request to formally execute the component includes data and parameter information.

As described above, when an error, etc., has not occurred in the provisional execution phase, the flow executing unit 301 performs a formal execution phase.

Here, in step S1211 described above, the data is the electronic file received from the web service processing unit 120 (the electronic file included in the request to execute the process flow), having a data format “InputStream”.

Furthermore, in step S1211 described above, the parameter information is each of the parameter information items defined at “parameters” in the process definition 1104 in the process flow information 1100 of FIG. 8. That is, the execution request for the component at step S1211 described above includes parameter information “language”:“English” and parameter information “outputType”:“pdf”.

When the OCR component 1310 receives the request to formally execute the component, the OCR component 1310 uses the data and the parameter information included in the formal execution request, to perform the formal execution (step S1212).

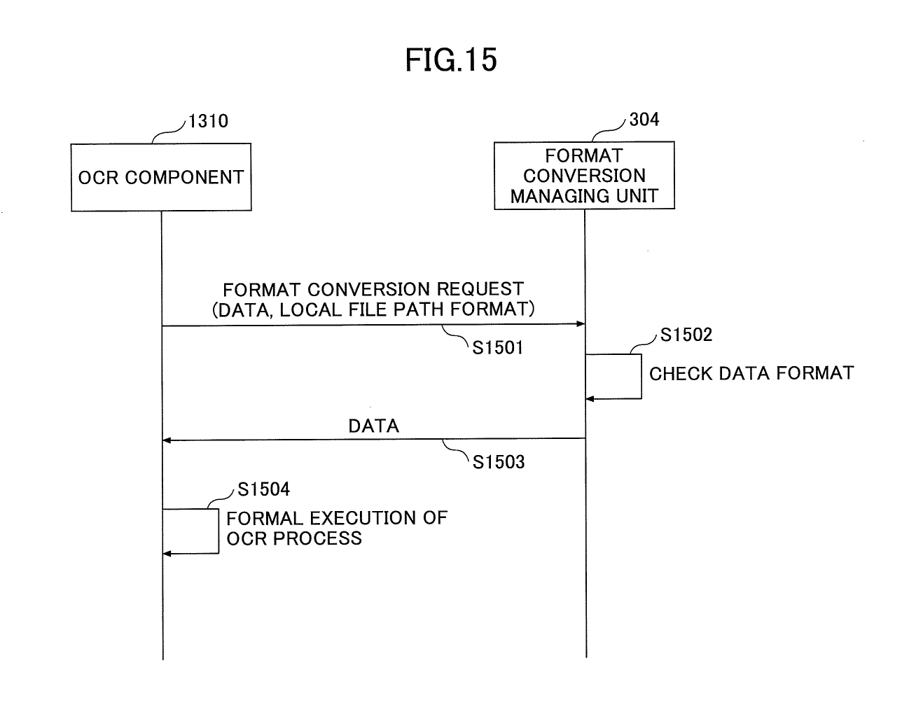

Here, a description is given of the process of formally executing the OCR component 1310, by referring to FIG. 15. FIG. 15 a sequence diagram of an example of a process of formally executing the OCR component 1310 according to the present embodiment.

When the OCR component 1310 receives the request to formally execute the component, the OCR component 1310 sends a format conversion request to the format conversion managing unit 304 (step S1501). Note that the format conversion request includes data and a specification of “LocalFilePath” indicating the data format that can be handled by the OCR component 1310.

When the format conversion managing unit 304 receives the format conversion request, the format conversion managing unit 304 checks whether the data format of the data included in the format conversion request and the specified data format match each other (step S1502).

Here, the data format of the data included in the format conversion request is “LocalFilePath”, and the specified data format is also “LocalFilePath”. Therefore, the format conversion managing unit 304 determines that the data format of the data included in the format conversion request and the specified data format match each other.

Then, the format conversion managing unit 304 sends the data included in the format conversion request, to the OCR component 1310 (step S1503). As described above, when the OCR component 1310 determines, in the process of checking the data format (the process of step S1502), that the data format of the data and the specified data format match each other, the format conversion managing unit 304 does not generate format conversion.

When the OCR component 1310 receives data from the format conversion managing unit 304, the OCR component 1310 uses the parameter information to perform a process of formally executing an OCR process (step S1504).

That is, the OCR component 1310 performs an OCR process on the electronic file indicated by the data (the data format “LocalFilePath”), by the OCR processing unit 131 of the document service unit 130. At this time, the OCR component 1310 sets the OCR language as “English” and performs an OCR process on the electronic file, and then sets the data format of the electronic file that has undergone the OCR process as “PDF”.

Then, the OCR component 1310 returns data indicating the processing result to the flow executing unit 301. Note that the data returned here is data (data format “LocalFilePath”) indicating the electronic file that has undergone the OCR process by the OCR component 1310.

Referring back to FIG. 12, the flow executing unit 301 sends a request to formally execute the component, to the delivery A component 1320 (step S1213). Note that the request to formally execute the component includes data and parameter information.

Here, in step S1213 described above, the data is the data returned from the OCR component 1310 (that is, data indicating the electronic file that has undergone the OCR process (data format “LocalFilePath”).

Furthermore, in step S1213 described above, the parameter information is each of the parameter information items defined at “parameters” in the process definition 1105 in the process flow information 1100 of FIG. 8.

That is, the request to formally execute the component in step S1213 described above includes parameter information “filename”:null and parameter information “folder”:null. Furthermore, the request to formally execute the component in step S1213 described above includes user specified information “filename”:“sample.pdf” and user specified information “folder”:“folder1” received from the web service processing unit 120.

When the delivery A component 1320 receives the request to formally execute the component, the delivery A component 1320 uses the data, the parameter information, and the user specified information included in the formal execution request, to perform the formal execution (step S1214).

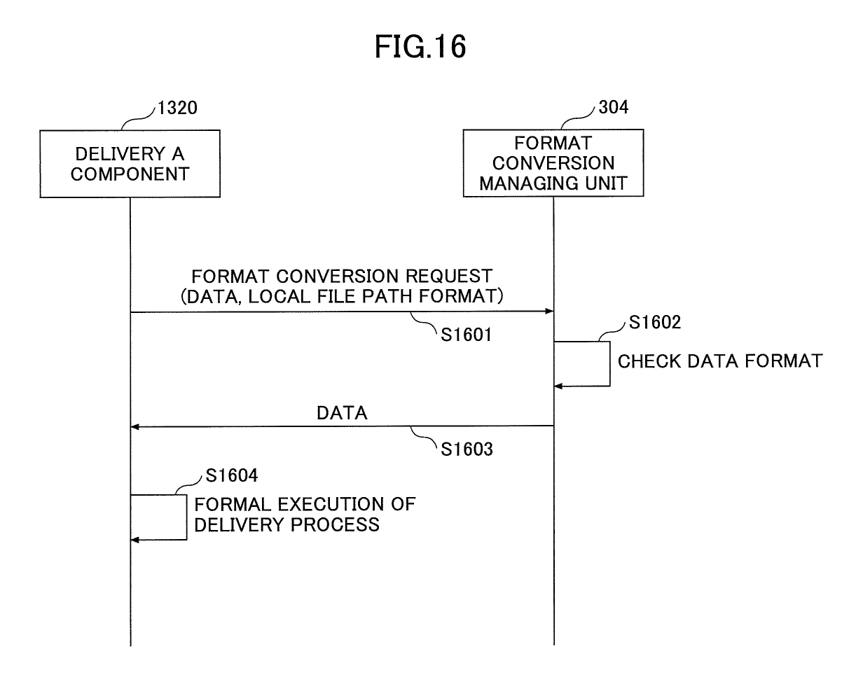

Here, a description is given of the process of formally executing the delivery A component 1320, by referring to FIG. 16. FIG. 16 is a sequence diagram of an example of a process of formally executing the delivery A component 1320 according to the present embodiment.

When the delivery A component 1320 receives the request to formally execute the component, the delivery A component 1320 sends a format conversion request to the format conversion managing unit 304 (step S1601). Note that the format conversion request includes data and a specification of “LocalFilePath” indicating the data format that can be handled by the delivery A component 1320.

When the format conversion managing unit 304 receives the format conversion request, the format conversion managing unit 304 checks whether the data format of the data included in the format conversion request and the specified data format match each other (step S1602).

Here, the data format of the data included in the format conversion request is “LocalFilePath”, and the specified data format is also “LocalFilePath”. Therefore, the format conversion managing unit 304 determines that the data format of the data included in the format conversion request and the specified data format match each other.

Then, the format conversion managing unit 304 sends the data included in the format conversion request, to the delivery A component 1320 (step S1603). As described above, when the format conversion managing unit 304 determines, in the process of checking the data format (the process of step S1602), that the data format of the data and the specified data format match each other, the format conversion managing unit 304 does not generate format conversion.

When the delivery A component 1320 receives data from the format conversion managing unit 304, the delivery A component 1320 uses the data, the parameter information, and the user specified information to perform a process of formally executing an uploading process to the storage A (step S1604).

That is, first, the delivery A component 1320 defines user specified information in the parameter information as “filename”:“sample.pdf” and “folder”:“folder1”. Next, the delivery A component 1320 uses the parameter information “filename”:“sample.pdf” and “folder”:“folder1” to set the file name of the electronic file indicated by the data as “sample.pdf”. Then, the delivery A component 1320 uploads (stores) the electronic file in the folder having the folder ID “folder1” in the storage A.

Note that the delivery A component 1320 sends a request to upload the electronic file to the file processing unit 141 of the external service cooperating unit 140₁ corresponding to the storage A (external storage system 30₁). That is, for example, the delivery A component 1320 uses an API defined in the common I/F 1411 as “storageA/process/folders”, to upload the electronic file.

Then, the delivery A component 1320 returns data indicating the processing result to the flow executing unit 301. Note that the data returned here is data indicating the processing result of the delivery A component 1320 (for example, data indicating that the uploading of the electronic file has successfully ended).

As described above, the service providing system 10 according to the present embodiment can provide the “OCR delivery A” service to a user of the device 20. At this time, the service providing system 10 according to the present embodiment provisionally executes the sequence of processes for implementing the service, and when an error, etc., does not occur in the provisional execution, the service providing system 10 formally executes the sequence of processes.

Accordingly, for example, the service providing system 10 according to the present embodiment can check whether there is an error in the parameter information used for executing the sequence of processes, whether the communication with an external service is disabled, and whether there is an error in the format of the electronic file, etc., before formally executing the sequence of processes.

Note that the service providing system 10 according to the present embodiment performs the provisional execution of the sequence of processes for implementing the service to be provided to the user of the device 20, and subsequently performs the formal execution of the sequence of processes; however, the present embodiment is not limited as such, and the provisional execution may not be performed.

For example, the user of the device 20 may be able to select whether to perform the provisional execution in the application screen, etc. In this case, in step S911 described above, the device 20 is to send the request to execute the process flow including information indicating whether to perform the provisional execution, to the web service processing unit 120.

Furthermore, for example, information indicating whether to perform the provisional execution (a flag, etc.) may be defined in the process flow information 1100. In this case, the flow executing unit 301 is to determine whether to perform the provisional execution, based on a flag, etc., defined in the process flow information 1100 acquired from the application managing unit 111.

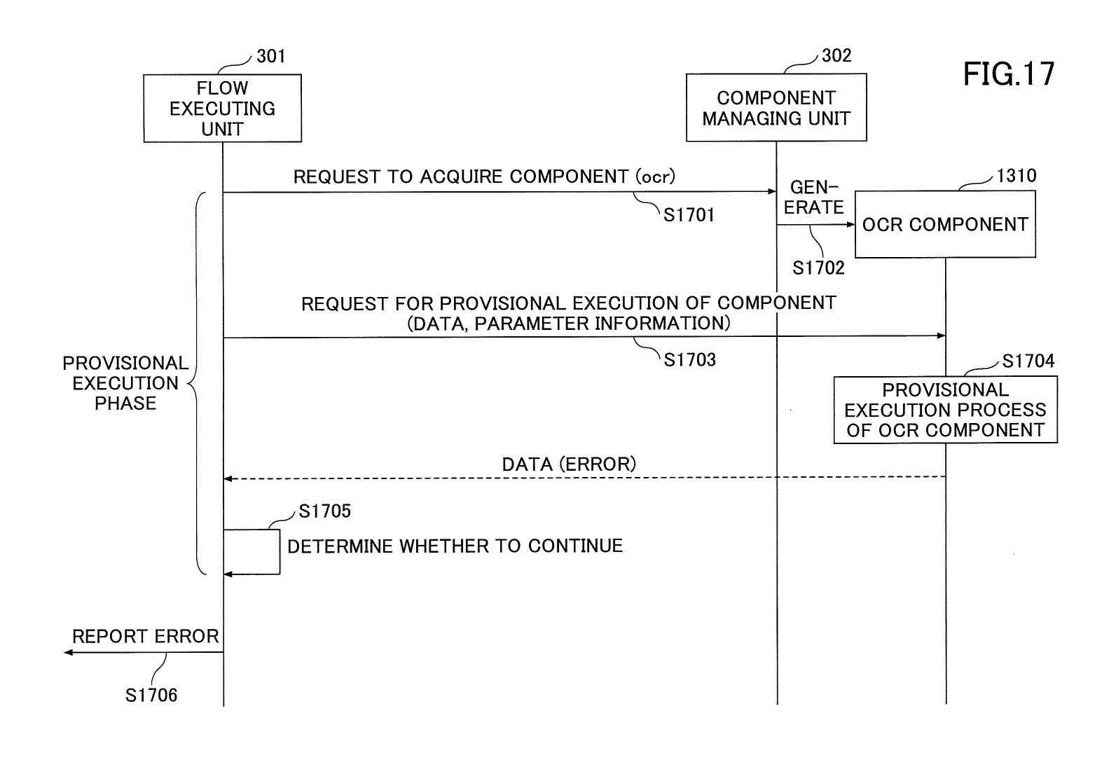

Next, a description is given of a case where an error, etc., occurs in the provisional execution phase in the process of executing the process flow for implementing the “OCR delivery A” service, by referring to FIG. 17. FIG. 17 is a sequence diagram of another example of the process of executing the process flow according to the present embodiment. Note that the processes of steps S1701 through S1703 of FIG. 17 are the same as the processes of steps S1201 through S1203 of FIG. 12, and therefore descriptions of these steps are omitted.

After step S1703, when the OCR component 1310 receives a request to provisionally execute the component, the OCR component 1310 uses the data and the parameter information included in the provisional execution request to perform a provisional execution process (step S1704).

Here, in the following description, it is assumed that an error, etc., has occurred in the provisional execution process of the OCR component 1310 in step S1704 described above. In this case, the OCR component 1310 returns data indicating that an error etc., has occurred, to the flow executing unit 301.

When the flow executing unit 301 receives the data from the OCR component 1310, the flow executing unit 301 determines whether to continue the process of executing the process flow (step S1705). That is, the flow executing unit 301 determines whether the data returned from the OCR component 1310 indicates that an error, etc., has occurred.

Here, in step S1704 described above, the data returned from the OCR component 1310 indicates that an error, etc., has occurred. In this case, the flow executing unit 301 reports to the device 20 that an error, etc., has occurred via the web service processing unit 120 (step S1706), and the process ends.

### Overview

As described above, the service providing system 10 according to the present embodiment performs the provisional execution of the sequence of processes for implementing the service to be provided to the user of the device 20, and subsequently performs the formal execution of the sequence of processes, when an error, etc., does not occur in the provisional execution.

Furthermore, when an error, etc., occurs in the provisional execution phase, the service providing system 10 according to the present embodiment reports than an error, etc., has occurred to the device 20, and does not perform the formal execution phase. That is, the service providing system 10 according to the present embodiment checks whether an error, etc., occurs in the sequence of processes in the provisional execution phase, and when an error, etc., occurs, the service providing system 10 does not perform the formal execution phase and reports that an error, etc., has occurred to the user of the device 20.

Accordingly, the service providing system 10 according to the present embodiment can check whether there is an error in the parameter information used for executing the sequence of processes, whether the communication with an external service is disabled, and whether there is an error in the format of the electronic file, etc., before formally executing the sequence of processes.

Furthermore, the service providing system 10 according to the present embodiment can report, at an early stage, that an error, etc., has occurred to the user of the device 20, when an error, etc., occurs in the sequence of processes for implementing a service. Therefore, when an error, etc., occurs in the sequence of processes, the service providing system 10 according to the present embodiment can reduce the waiting time of the user, and can also reduce the unnecessary consumption of system resources (for example, the CPU 16, etc.). Particularly, when an error, etc., occurs in a process executed at a latter stage among the processes included in the sequence of processes, the service providing system 10 according to the present embodiment can further reduce the waiting time of the user and unnecessary consumption of system resources.

According to one embodiment of the present invention, the waiting time in a case where an error occurs in a sequence of processes, can be reduced.

The information processing system, the information processing apparatus, and the information processing method are not limited to the specific embodiments described in the detailed description, and variations and modifications may be made without departing from the spirit and scope of the present invention.

What is claimed is:

1. An information processing system including one or more information processing apparatuses configured to implement various functions of the information processing system, the information processing system comprising:
a memory to store
flow information and flow identification information identifying the flow information, in association with each other, for each sequence of processes performed by using electronic data, the flow information defining program identification information identifying one or more programs for respectively executing the processes included in the sequence of processes, the flow information also defining an execution order of executing the one or more programs, and
computer-executable instructions; and
one or more processors configured to execute the computer-executable instructions such that the one or more processors execute a process including:
receiving, over a communication network, information relating to the electronic data and flow identification information, from one of one or more devices coupled to the information processing system, according to an operation input via a user interface of the one of one or more devices;
acquiring the flow information stored in association with the received flow identification information, among the flow information stored in the memory;
provisionally executing the sequence of processes using the electronic data based on the received information relating to the electronic data, by respectively provisionally executing the one or more programs identified by the program identification information defined in the acquired flow information, in the execution order defined in the acquired flow information; and
executing the sequence of processes using the electronic data based on the received information relating to the electronic data, by respectively executing the one or more programs identified by the program identification information defined in the acquired flow information, in the execution order defined in the acquired flow information, upon determining that an error has not occurred in the provisional execution of the sequence of processes.

2. The information processing system according to claim 1, wherein the one or more processors execute the process further including:
reporting that an error has occurred, to the one of one or more devices without executing the sequence of processes, upon determining that the error has occurred in the provisional execution of the sequence of processes.

3. The information processing system according to claim 1, wherein
the flow information further defines parameter information used for respectively executing the one or more programs, and
the provisional executing of the sequence of processes includes confirming whether the parameter information, which is used for respectively executing the one or more programs, is supported by the one or more programs.

4. The information processing system according to claim 1, wherein the provisional executing of the sequence of processes includes confirming whether at least one of a quantity of the electronic data used for executing the one or more programs, a number of pages included in the electronic data, and a size of the electronic data, exceed a predetermined upper limit that is set in advance.

5. The information processing system according to claim 1, wherein
the one or more programs include an external service program for executing a process relating to an external service, and
the external service program includes at least a program for executing a process of uploading the electronic data to the external service.

6. The information processing system according to claim 1, wherein the execution order is an order in which the program identification information is defined in the flow information.

7. An information processing apparatus comprising:
a memory to store
flow information and flow identification information identifying the flow information, in association with each other, for each sequence of processes performed by using electronic data, the flow information defining program identification information identifying one or more programs for respectively executing the processes included in the sequence of processes, the flow information also defining an execution order of executing the one or more programs, and
computer-executable instructions; and
one or more processors configured to execute the computer-executable instructions such that the one or more processors execute a process including:
receiving, over a communication network, information relating to the electronic data and flow identification information, from one of one or more devices coupled to the information processing apparatus, according to an operation input via a user interface of the one of one or more devices;
acquiring the flow information stored in association with the received flow identification information, among the flow information stored in the memory;
provisionally executing the sequence of processes using the electronic data based on the received information relating to the electronic data, by respectively provisionally executing the one or more programs identified by the program identification information defined in the acquired flow information, in the execution order defined in the acquired flow information; and
executing the sequence of processes using the electronic data based on the received information relating to the electronic data, by respectively executing the one or more programs identified by the program identification information defined in the acquired flow information, in the execution order defined in the acquired flow information, upon determining that an error has not occurred in the provisional execution of the sequence of processes.

8. An information processing method executed by a computer, the information processing method being implemented in an information processing system including
one or more information processing apparatuses configured to implement various functions of the information processing system, and
a memory to store flow information and flow identification information identifying the flow information, in association with each other, for each sequence of processes performed by using electronic data, the flow information defining program identification information identifying one or more programs for respectively executing the processes included in the sequence of processes, the flow information also defining an execution order of executing the one or more programs, the information processing method comprising:
receiving, over a communication network, information relating to the electronic data and flow identification information, from one of one or more devices coupled to the information processing system, according to an operation input via a user interface of the one of one or more devices;
acquiring the flow information stored in association with the received flow identification information, among the flow information stored in the memory;
provisionally executing the sequence of processes using the electronic data based on the received information relating to the electronic data, by respectively provisionally executing the one or more programs identified by the program identification information defined in the acquired flow information, in the execution order defined in the acquired flow information; and
executing the sequence of processes using the electronic data based on the received information relating to the electronic data, by respectively executing the one or more programs identified by the program identification information defined in the acquired flow information, in the execution order defined in the acquired flow information, upon determining that an error has not occurred in the provisional execution of the sequence of processes.
